(19) United States
(12) Patent Application Publication
(10) Pub. No.: US 2009/0117020 A1
(43) Pub. Date: May 7, 2009

(54) RAPID MICROWAVE-SOLVOTHERMAL SYNTHESIS AND SURFACE MODIFICATION OF NANOSTRUCTURED PHOSPHO-OLIVINE CATHODES FOR LITHIUM ION BATTERIES

(75) Inventors: Arumugam Manthiram, Austin, TX (US); Arumugam Vadivel Murugan, Austin, TX (US); Muraliganth Theivanayagam, Austin, TX (US)

Correspondence Address: CHALKER FLORES, LLP, 2711 LBJ FRWY, Suite 1036, DALLAS, TX, 75234, US

(73) Assignee: BOARD OF REGENTS, THE UNIVERSITY OF TEXAS SYSTEM, Austin, TX (US)

(21) Appl. No.: 12/139,323

(22) Filed: Jun. 13, 2008

Related U.S. Application Data
(60) Provisional application No. 60/985,544, filed on Nov. 5, 2007.

(51) Int. Cl. C01B 25/45

(52) U.S. Cl. 423/274; 423/306; 977/810

(57) ABSTRACT

The present invention includes methods, coatings, and a nanostructured phospho-olivine composition LiₓM_{y}PO₄, capable of being formed hydrothermally or solvothermally in aqueous solutions and non-aqueous solutions M is one or more elements selected from the group consisting of Fe, Mn, Co, Ti, Ni, Cu, V, Mo, Zn, Mg, Cr, Al, Ga, B, Zr, Nb or combination thereof and x is between 0 and 1 and y is between 0.8 and 1.2. The phospho-olivine may also have the compositions like LiₓFe_{1-y}M_{y}PO₄, wherein x is between 0 and 1, and y is between 0 and 1.

### CROSS-REFERENCES

This application claims benefit and priority from U.S. Provisional Application No. 60/985,544, filed Nov. 5, 2007, the contents of which are incorporated herein by reference.

### STATEMENT OF FEDERALLY FUNDED RESEARCH

This invention was made with U.S. Government support under Contract No. DE-AC03-76SF00098 (Subcontract No. 6712770) by DOE, the Office of Vehicle Technologies of the U.S. Department of Energy under Contract No. DE-AC02-05CH11231 and 20-52022-UT0507 by NASA. The government has certain rights in this invention.

### TECHNICAL FIELD OF THE INVENTION

The present invention relates in general to the field of cathode materials, and more specifically to rapid microwave-solvothermal synthesis employing aqueous and nonaqueous solvents and surface modification of nanostructured phospho-olivine cathodes for lithium ion batteries.

### BACKGROUND OF THE INVENTION

Without limiting the scope of the invention, its background is described in connection with phospho-olivine cathodes for lithium ion batteries. Generally, lithium ion batteries have become common place for portable electronic devices such as laptop computers and cell phones due to their higher energy density compared to other rechargeable systems. They are also being intensively pursued for transportation applications such as hybrid electric vehicles (HEV) and plug-in hybrid electric vehicles (PHEV). Conventional lithium ion batteries use the layered LiCoO₂ as a cathode (i.e., positive electrode) material. The high cost and environmental concerns associated with cobalt as well as the safety concerns of lithium cobalt oxide have hampered the development of lithium ion battery technology for HEV and PHEV applications.

Alternative materials are being explored for HEV and PHEV, but they have their own advantages and disadvantages. For example, LiFePO₄ crystallizing in the olivine structure is appealing due to the inexpensiveness of iron and its benign environmental impact; however, the olivine LiFePO₄ has a low electronic conductivity and low lithium diffusivity. These limitations translate to a poor rate capability for the LiFePO₄ cathodes and make it difficult to make full use of its capacity in lithium ion batteries.

The electrochemical performances have been found to increase by decreasing the particle size of LiFePO₄ via various synthetic methods under different conditions including solid-state [Padhi, A. K., Nanjundasawamy, K. S., & Goodenough, J. B., Phospho-olivines as positive electrode materials for rechargeable lithium batteries. J. Electrochem. Soc, 144, 1188-1194 (1997)] and ball-milling [Hosoya et al U.S. Pat. No. 7,101,521 B2, September 2006]. However, these methods require repeated regrinding and heat-treatment at high temperatures (500-800° C.) for several hours (12-24 hours) in inert or reducing atmospheres, which lead to increase in particle size and a decrease in electrochemical performance.

As a result, soft-chemical routes to synthesize LiFePO₄ at low temperatures using aqueous and non-aqueous reaction medium have been explored (e.g., precipitation methods [Arnold, G., Garche, J., Hemmer, R., Ströbele, S., Vogler, C. & Wohlfahrt-Mehre, M. Fine-particle lithium iron phosphate LiFePO₄ synthesized by a new low-cost aqueous precipitation technique. J. Power Sources, 119-121, 247-251 (2003)], sol-gel process [Yang, J. & Xu, J. J. Nonaqueous Sol-gel synthesis of high-performance LiFePO₄, Electrochem. Solid-State Lett., 7, A515-A518 (2004)], refluxing [Kim, D.-H. & Kim, J. Synthesis of LiFePO₄ nanoparticle in polyol medium and their electrochemical properties, Electrochem. Solid-State Lett, 9, A439-A442 (2006)], and hydrothermal techniques [Ellis, B., Kan, W. H., Makahnouk, W. R. M., & Nazar, L. F. Synthesis of nanocrystals and morphology control of hydrothermally prepared LiFePO₄. J. Mater. Chem. 17, 3248-3254 (2007)]). However, these methods often involve lengthy procedures with several steps and need longer reaction times for the formation of well crystalline phase. In addition, post heat-treatment processing at high temperatures in reducing atmospheres is necessary to obtain well crystalline LiFePO₄, resulting in unwanted particle growth that is detrimental to the characteristics of LiFePO₄ electrodes with low lithium ion conductivity.

### SUMMARY OF THE INVENTION

The present inventors recognized the need for an efficient method of synthesis involving simplified preparation procedures and shorter reaction times. The present inventors recognized that the one-pot microwave-assisted, solution-based synthesis method offers several advantages over conventional routes. For example, the microwave-assisted synthesis method of the present invention provides cleanliness, short reaction times, and energy economy while providing small particle size with a uniform size distribution in a shorter reaction time.

Although, microwave irradiated synthesis of LiFePO₄ using a mixture of its solid-state precursors under inert atmosphere has been pursued [Higuchi, M., Katayama, K., Azuma, Y., Yukawa, M. & Suhara, M. Synthesis of LiFePO₄ cathode material by microwave processing, J. Power Sources, 119-121, 258-261 (2003); Wang, L., Huang, Y., Jiang, R. & Jia, D. Preparation and characterization of nano-sized LiFePO₄ by low heating solid-state coordination method and microwave heating, Electrochim Acta, 52, 6778-6783 (2007)], there has been difficulty in obtaining pure-phase LiFePO₄ due to the oxidation of Fe²⁺ to Fe³⁺ or the hydrolysis of Fe²⁺ to Fe³⁺ in aqueous solutions and the consequent formation of impurity phases containing Fe³⁺. In addition, processes to reduce this oxidation have been generally tedious, ineffective and have led to carbon residues. However, most importantly, the products prepared by these processes have had a reduced discharge capacity of 125 mAh/g, which is much lower than the theoretical value of about 170 mAh/g.

As a result, the present inventors have developed a new microwave-solvothermal method (including microwave-hydrothermal method) of synthesizing LiFePO₄ that produces highly crystalline nanostructured LiFePO₄ within a short period of time (e.g., 5-15 minutes) at reasonable temperatures (e.g., 300° C.) without any further heating in a furnace or in reducing atmospheres.

The present invention provides an enhanced capacity and rate capability for LiFePO₄ by doping with a number of cations and coating with electronically conducting additives such as carbon, multi-walled carbon nanotubes (MWCNT), and conjugated polymers. The capacity retention and rate capability increase with decreasing particle size, certain cation doping, and the incorporation of electronically conductive additives.

For example, U.S. Pat. No. 7,087,348, entitled, “coated electrode particles for composite electrodes and electrochemical cells,” disclosed electrodes for use in electrochemical devices. More particularly, coated electrode particles for use in solid electrochemical cells and materials and systems for improving electronic conductivity and repulsive force characteristics of an electrode network are disclosed. An article containing a plurality of distinct first particles that form an electrode network in which the distinct first particles are coated with a system of electrically conductive material is also disclosed. In some embodiments, the coating layer also includes a low refractive index material. In some embodiments, the coating layer of the electroactive material includes a plurality of second particles.

The present invention provides highly crystalline LiFePO₄ nanorod compositions and methods of making compositions within a short reaction time of 5-15 minutes at <300° C. by a novel microwave-solvothermal (hereafter referred to as “MW-ST”) process and a microwave-hydrothermal (hereafter referred to as “MS-HT”) process. In order to improve the electrical conductivity, both an ex situ carbon coating by heating at 700° C. with sucrose the LiFePO₄ obtained by the MW-ST method and an in situ carbon coating by carrying out the MW-HT process in presence of glucose (MW-HT carbonization) followed by heating at 700° C. for 1 hour.

The MW-ST method offers smaller size nanorods (25±6 nm width and up to 100 nm length) compared to the MW-HT method (225±6 nm width and up to 300 nm length). Annealing at 700° C. improves the rate capability and cyclability without significant particle growth due to the structural order of carbon and electronic conductivity. Moreover, the LiFePO₄/C nanocomposite obtained by the MW-ST method offers higher initial discharge capacity than that obtained by the MW-HT method due to a smaller particle size, illustrating that both lithium ion diffusion and electronic conductivity play a critical role in controlling the electrochemical properties.

The present invention provides a low cost manufacturing process that offers high performance nanostructured phospho-olivine cathodes in a consistent and reliable manner without requiring rigorous quality check during the manufacturing process. Specifically, the invention focuses on the preparation of nanostructured LiₓM_{y}PO₄, where 0<x≦1.2, 0.8≦y≦1.2, and M is at least one element selected from the group consisting of Fe, Mn, Co, Ti, Ni, Cu, V, Mo, Zn, Mg, Cr, Al, Ga, B, Zr and Nb [or] combinations thereof, by a simple microwave-solvothermal process and a coating of the product obtained by electronically conductive additives.

In addition, the present invention provides a simple, clean process involving low temperatures and short reaction times without requiring any post heat treatment process in inert or reducing gas atmospheres, while offering significant energy and cost savings. Moreover, the present invention provides a low cost manufacturing process to produce high quality nanocrystalline cathode powder in a consistent and reliable manner with good control on particle size and distribution, while providing materials with high electronic and ionic conductivities needed for high power applications.

The present invention includes a nanostructured phospho-olivine composition having the olivine LiₓM_{y}PO₄ structure. M is one or more elements selected from the group consisting of Fe, Mn, Co, Ti, Ni, Cu, V, Mo, Zn, Mg, Cr, Al, Ga, B, Zr, Nb or combination thereof and x is between 0 and 1.2 and y is between 0.8 and 1.2. The composition may also have the phospho-olivine LiₓFe_{1-y}M_{y}PO₄, wherein x is between 0 and 1, y is between 0 and 1.

In addition, the present invention also provides a method of making a nanostructured phospho-olivine cathode materials by dissolving lithium hydroxide and one or more metal salts, adding H₃PO₄ to the lithium hydroxide and the one or more metal salts to form a precursor solution with a 1:1:1 molar ratio of Li:M:P, heating solvothermally the precursor solution with a microwave irradiated synthesis system, and separating a LiMPO₄ material from the precursor solution. The one or more metal salts may be Fe, Mn, Co, Ti, Ni, Cu, V, Mo, Zn, Mg, Cr, Al, Ga, B, Zr, Nb or combination thereof. The polymer may be an electronically conductive polymer, a doped polymer, an electronically and ionically conductive polymer, or a combination thereof, e.g., polypyrrole, polyaniline, polythiophene, poly-p-phenylene vinylene, poly(alkyl and alkoxythiophenes) such as poly(3,4-ethylenedioxythiophene) (PEDOT) and their substituted derivatives.

The present invention also include a method of making a doped nanostructured phospho-olivine materials by dissolving lithium hydroxide, iron (II) salt and one or more metal salts, adding H₃PO₄ to the lithium hydroxide and the one or more metal salts to form a precursor solution with a 1:1:1 molar ratio of Li:Fe(M):P, heating solvothermally the precursor solution with a microwave irradiated synthesis system and separating a LiₓFe_{1-y}M_{y}PO₄ material from the precursor solution. The polymer may be an electronically conductive polymer, a doped polymer or a combination thereof (e.g., polypyrrole, polyaniline, polythiophene, poly-p-phenylene vinylene, poly(alkyl and alkoxythiophenes) such as poly(3,4-ethylenedioxythiophene) (PEDOT) and their substituted derivatives).

A method of making a nanostructured phospho-olivine hybrid composition by combining a polymer with a nanostructured phospho-olivine. The nanostructured phospho-olivine is formed by dissolving a lithium hydroxide complex and one or more metal salts, adding H₃PO₄ to the lithium hydroxide complex and the one or more metal salts to form a precursor solution with a 1:1:1 molar ratio of Li:M:P, heating solvothermally the precursor solution with a microwave irradiated synthesis system, and separating the LiMPO₄ nanostructured phospho-olivine material from the precursor solution.

### BRIEF DESCRIPTION OF THE DRAWINGS

For a more complete understanding of the features and advantages of the present invention, reference is now made to the detailed description of the invention along with the accompanying figures and in which:

FIG. 1 is an image of the results of X-ray diffraction analysis of LiFePO₄ nanorods (or nanosheets) prepared by the microwave-solvothermal method of the present invention;

FIG. 2 is an image of the XRD pattern after encapsulating the LiFePO₄ nanorods at room temperature within the mixed electronically and ionically conducting p-Toluene sulfonic acid (p-TSA) doped poly(3,4-ethylenedioxythiophene) (PEDOT) to form an organic-inorganic nanohybrid;

FIG. 3 is an image of the XRD pattern of LiFePO₄ coated with carbon by firing at 700° C. for 1 hour;

FIG. 4A is an SEM images of LiFePO₄ prepared by microwave-solvothermal process that has a nanoflower-like morphology and FIG. 4B is an SEM image after encapsulating the LiFePO₄ nanorods at room temperature within the mixed electronically and ionically conducting p-TSA doped poly(3,4-ethylenedioxythiophene) (PEDOT) to form an organic-inorganic nanohybrid;

FIGS. 5A, 5B and 5C are TEM images of LiFePO₄ nanorods prepared by the microwave-solvothermal method, and FIG. 5D is a TEM image of LiFePO₄ nanorods encapsulated within the p-TSA doped PEDOT polymer;

FIG. 6 shows TEM images of LiFePO₄ after encapsulating by electronically conducting multi-walled carbon nanotubes (MWCNT) at room temperature;

FIG. 7 is a plot comparing the first charge-discharge profiles of LiFePO₄ nanorods prepared by the microwave-solvothermal method and after encapsulating the LiFePO₄ nanorods within p-TSA doped-PEDOT at C/15 rate between 4.3 and 2.0 V. The inset shows the corresponding cycle life data;

FIG. 8 is a plot comparing the first charge-discharge profiles of LiFePO₄ nanorods prepared by the microwave-solvothermal method and after encapsulating the LiFePO₄ nanorods within multi-walled carbon nanotubes (MWCNT) at C/15 rate between 4.3 and 2.0 V. The inset shows the corresponding cycle life data;

FIG. 9 is a plot comparing the first charge-discharge profiles of LiFePO₄ nanorods prepared by the microwave-solvothermal method and after encapsulating the LiFePO₄ nanorods within carbon at C/15 rate between 4.3 and 2.0 V. The inset shows the corresponding cycle life data;

FIG. 10 is a plot comparing the first charge-discharge profiles of LiFePO₄ and LiFe_{0.95}Zn_{0.05}PO₄ nanorods prepared by the microwave-solvothermal method at C/15 rate between 4.3 and 2.0 V. The inset shows the corresponding cycle life data;

FIG. 11A is a graph that compares the cyclability and FIG. 11B is a graph that compares the rate capability of LiFePO₄ nanorods synthesized by the microwave-solvothermal method and after encapsulating the LiFePO₄ nanorods within p-TSA doped-PEDOT;

FIG. 12 is a plot comparing the rate capability of LiFePO₄ nanorods prepared by the microwave-solvothermal method and after encapsulating the LiFePO₄ nanorods within multi-walled carbon nanotubes (MWCNT);

FIG. 13 is a plot comparing the rate capability of LiFePO₄ nanorods prepared by the microwave-solvothermal method and after encapsulating the LiFePO₄ nanorods within carbon;

FIG. 14 is a plot comparing the rate capability of pristine LiFePO₄ and LiFe_{0.95}Zn_{0.05}PO₄ electrodes;

FIG. 15 is a schematic of the one pot synthesis of LiFePO₄/C nanocomposite by a microwave assisted hydrothermal (MW-HT) process involving hydrothermal carbonization of glucose;

FIGS. 16A and 16B are plots of the XRD patterns of synthesized LiFePO₄/C nanocomposite obtained by the facile one step microwave-hydrothermal process (about 15 minutes) and the LiFePO₄/C nanocomposite after heating at 700° C. for 1 hour in 2% H₂-98% Ar, respectfully; FIG. 16C is a Raman spectrum of the LiFePO₄/C nanocomposite;

FIGS. 17A and 17B are TEM images of LiFePO₄/C nanocomposite;

FIGS. 18A and 18B are discharge profiles of LiFePO₄/C nanocomposite obtained by the one step microwave-hydrothermal carbonization method, before and after heat treating, respectively;

FIG. 19 is a graph of the cyclability data for the as-synthesized LiFePO₄/C sample, which exhibits some capacity fade, while the annealed sample exhibits excellent capacity retention;

FIG. 20 is an illustration of the microwave-hydrothermal (MW-HT) and microwave-solvothermnal (MW-ST) synthesis processes;

FIGS. 21A and 21B show the XRD patterns of the as-synthesized LiFePO₄ obtained by the microwave irradiated solvothermal (MW-ST) method;

FIGS. 22A-22D shows the XRD patterns of the LiFePO₄ and LiFePO₄/C nanocomposite prepared by the MW-HT method shown in FIG. 20B;

FIGS. 23A and 23B show the SEM images of the as-synthesized LiFePO₄ obtained by the MW-ST method and the LiFePO₄/C composite obtained by a subsequent ex situ coating of carbon on LiFePO₄. FIGS. 23C and 23D show the SEM images of the as-synthesized LiFePO₄/C nanocomposite obtained by the MW-HT method with glucose and the product obtained after subsequent heating;

FIG. 24 is a TEM image that demonstrates the well-defined crystalline nanorod morphologies with controlled size of the LiFePO₄ /C nanocomposites;

FIGS. 25A-25C are graphs that show the Raman spectra of as-synthesized LiFePO₄.

FIGS. 26A and 26B are graphs of the electrochemical properties of the LiFePO₄ and LiFePO₄/C nanocomposite;

FIGS. 27A and 27B are graphs that compare the first charge-discharge profiles recorded at C/10 rate between 2.0 and 4.3 V and the cyclability of the as-synthesized LiFePO₄ obtained by the MW-HT method;

FIGS. 28A and 28B are graphs that compare the rate capabilities of the as-synthesized LiFePO₄ nanorods obtained by the MW-ST method and LiFePO₄/C nanocomposite obtained by an ex situ carbon coating of the MW-ST LiFePO₄ nanorods by heating with sucrose;

FIGS. 29A, 29B and 29C are graphs that compare the rate capabilities of the LiFePO₄ nanorods obtained by the MW-HT method followed by heating, as-synthesized LiFePO₄/C nanocomposite obtained by an in situ carbon coating with glucose during the MW-HT process, and after heating the LiFePO₄/C nanocomposite in FIG. 29B at 700° C. for 1 hour in a flowing 2% H₂-98% Ar atmosphere;

FIG. 30 is a graph that compare the rate capabilities of LiFePO₄/C nanocomposite obtained by an ex situ carbon coating of the MW-ST LiFePO₄ nanorods by heating with sucrose and LiFePO₄/C nanocomposite obtained by an in situ carbon coating with glucose during the MW-HT process, followed by heating;

FIG. 31 are images of the product at various stages of the MW-ST process to produce nano LiMPO₄ (M=Mn, Fe, Co, Ni) and subsequent nanocomposite formation with MWCNT at ambient temperatures;

FIG. 32 is a graph of the XRD patterns of the nano LiMPO₄ (M=Mn, Fe, Co, Ni) prepared by the MW-ST method within 5 to 15 minutes at 300° C.;

FIGS. 33A, 33B, 33C and 33D are TEM images of LiMPO₄ (M=Mn, Fe, Co, Ni) nanosheets prepared by the MW-ST method within 5 to 15 minutes at 300° C. at higher magnification; and

FIGS. 34A, 34B, 34C, 34D, 34E and 34F are graphs that compare the discharge capacity at various C-rates of the LiMPO₄ (M=Mn, Co, Ni) nanosheets before and after networking with MWCNT.

### DETAILED DESCRIPTION OF THE INVENTION

While the making and using of various embodiments of the present invention are discussed in detail below, it should be appreciated that the present invention provides many applicable inventive concepts that can be embodied in a wide variety of specific contexts. The specific embodiments discussed herein are merely illustrative of specific ways to make and use the invention and do not delimit the scope of the invention.

To facilitate the understanding of this invention, a number of terms are defined below. Terms defined herein have meanings as commonly understood by a person of ordinary skill in the areas relevant to the present invention. Terms such as “a”, “an” and “the” are not intended to refer to only a singular entity, but include the general class of which a specific example may be used for illustration. The terminology herein is used to describe specific embodiments of the invention, but their usage does not delimit the invention, except as outlined in the claims.

The present invention provides a fast, low cost method to produce high performance nanostructured phospho-olivines by a novel microwave-solvothermal method. The process offers highly crystalline nanostructured LiFePO₄ within short time frames (e.g., 15 minutes or less) and at temperatures as low as 300° C. without any further heating in a furnace or in reducing atmospheres. The present invention also provides enhancements to the capacity and rate capability of pristine LiFePO₄ by doping with a number of cations and coating with electronically conducting additives such as carbon, multi-walled carbon nanotubes (MWCNT), and conjugated polymers. The capacity retention and power capability increase with decreasing particle size, cation doping, and the incorporation of electronically conductive additives. The phospho-olivines and phospho-olivine based hybrid cathodes exhibit superior capacity retention, high rate (power) capability, and excellent storage characteristics compared to the conventional spinel LiMn₂O₄ and layered LiCoO₂ cathodes.

Lithium-ion batteries have revolutionized the portable electronics market, but the high cost, limited power capability, and safety concerns associated with the LiCoO₂ cathode remain to be an impediment to develop the lithium ion technology for transportation applications. In this regard, the phospho-olivine LiFePO₄ has attracted considerable attention in recent years as Fe is inexpensive and environmentally benign and the covalently bonded PO₄ groups offer excellent safety [Arico, A. S., Bruce, P., Scrosati, B., Tarascon, J. M., & van Shalk-wijk, W. Nanostructured materials for advanced energy conversion and storage devices. Nature Mater. 4, 366-377 (2005); Herle, P. S., Ellis, B., & Nazar, L. F. Nano-network conduction in olivine phosphates. Nature Mater. 3, 147-152 (2004)].

The major drawback with LiFePO₄ is the poor lithium ion and electronic conductivity, resulting in inherently poor power capability [Chung, S.-Y., Bloking, J. T. & Chiang, Y.-M. Electronically conductive phospho-olivines as lithium storage electrodes. Nature Mater. 2, 123-128 (2002); Ellis, B., Perry, L. K., Ryan, D. H. & Nazar, L. F. Small polaron hopping in LiₓFePO₄ solid solutions: Coupled lithium-ion and electron mobility. J. Am. Chem. Soc. 128, 11416-11422 (2006)]. This difficulty has been overcome in recent years by decreasing the lithium diffusion length via nanosize particles and increasing the electronic conductivity by a coating of the particles with conductive species like carbon. However, considering the multiple steps involved and post annealing treatments at >600° C. in reducing atmospheres, manufacturing of nanosize LiFePO₄ with controlled particle size and uniform properties in a consistent and cost-effective manner for large volume applications will be a serious scientific challenge. The present inventors provide a method for the rapid microwave-solvothermal synthesis of nanostructured LiFePO₄ within 15 minutes at temperatures as low as 300° C. without requiring any post heating in a furnace or reducing gaseous atmosphere. Subsequent ambient-temperature coating of the nanosize LiFePO₄ with mixed electronically and ionically conducting doped poly(3,4-ethylenedioxythiophene) (PEDOT) offers 95% of the theoretical capacity with excellent cyclability and power capability.

While highly oxidized redox couples such as Co^{3+/4+} and Ni^{3+/4+} are generally desired in simple oxides like LiCoO₂ to maximize the cell voltage, they invariably lead to chemical instability and safety concerns. Recognizing this, oxides with polyanions like (XO₄)²⁻ (X=S, Mo, and W) were first initiated by Manthiram and Goodenough [Manthiram, A. & Goodenough, J. B. Lithium Insertion into Fe₂(MO₄)₃ Frameworks: Comparison of M=W with M=Mo J. Solid State Chem. 71, 349-360 (1987); Manthiram, A. & Goodenough, J. B. Lithium Insertion into Fe₂(SO₄)₃-type Frameworks. J. Power Sources 26, 403-406 (1989)] as lithium insertion/extraction hosts in the late 1980's since the covalently bonded groups like (SO₄)²⁻ can lower the redox energies of lower valent, chemically more stable couples like Fe^{3+/4+} through inductive effect and increase the cell voltage. Following this, the phospho-olivine LiFePO₄ consisting of a hexagonal close-packed oxygen framework with edge-shared LiO₆ octahedra, corner-shared FeO₆ octahedra, and PO₄ tetrahedra was identified as a cathode by Padhi et al [Padhi, A. K., Nanjundasawamy, K. S., & Goodenough, J. B., Phospho-olivines as positive electrode materials for rechargeable lithium batteries. J. Electrochem. Soc, 144, 1188-1194 (1997)] in 1997. The one-dimensional chains formed by the edge-shared LiO₆ octahedra along the b-axis of the orthorhombic structure lead to poor lithium ion conductivity. On the other hand, the little or limited solubility between LiFePO₄ and FePO₄ and the localized Fe²⁺ or Fe³⁺ lead to poor electronic conductivity. The inferior lithium ion and electronic conductivites result in poor utilization of the available capacity and limited power capability, a performance parameter critical for vehicle applications.

Consequently, tremendous efforts have been made to overcome the electronic and ionic transport limitations by cationic doping, decreasing the particle size, and coating with electronically conducting agents [Wang, C., & Hong. J., Ionic/Electronic conducting characteristics of LiFePO₄ cathode materials, Electrochem. Solid-State Lett. 10, A65-A69 (2007); Delacourt, C., Poizot, P., Levasseur, S. & Masquelier, C. Size effects on carbon-free LiFePO₄ powders: The key to superior energy density. Electrochem. Solid-State Lett. 9, A352-A355 (2006)]. In particular, the aliovalent doping (e.g. Zr⁴⁺ and Nb⁵⁺) reported by Chung et al. [Chung, S.-Y., Bloking, J. T. & Chiang, Y.-M. Electronically conductive phospho-olivines as lithium storage electrodes. Nature Mater. 2, 123-128 (2002)] to increase the conductivity by several orders of magnitude has stimulated considerable interest and controversy in the field. Nanosize LiFePO₄ coated with electronically conductive carbon has recently been shown to exhibit high power capability, and there is enormous worldwide interest to develop the phospho-olivines for hybrid electric vehicle applications. Nanosize LiFePO₄ has been synthesized by soft chemistry procedures such as precipitation, sol-gel, refluxing, and hydrothermal methods as they provide intimate mixing of the component elements in solution, allowing the formation finer particles by rapid homogeneous nucleation of LiFePO₄.

However, these methods often involve longer reaction times to realize the formation of well crystalline phase. More importantly, they require post heat-treatment processing at temperatures as high as 700° C. in reducing atmospheres (e.g. 5% hydrogen) for longer periods of time (about 24 hours) to achieve high degree of crystallinity and coating with conductive carbon. Such tedious processes not only increase the manufacturing cost and lead to unwanted particle growth, but may also necessitate strict quality check involving additional cost during large volume production needed for automotive applications.

In this regard, microwave synthesis is appealing as it involves short reaction times, providing cost savings [Rao, K. J., Vaidhyanathan, B., Ganguli, M., & Ramakrishnan, P. A. Synthesis of Inorganic Solids Using Microwaves, Chem. Mater. 11, 882-895 (1999); Vadivel Murugan, A., Kwon, C. W., Campet, G., Kale, B. B., Mandale, A. B., Sainker, S. R., Gopinath, C. S. & Vijayamohanan, K. A novel approach to prepare poly (3,4-ethylenedioxythiophene) nanoribbons between V₂O₅ layers by microwave irradiation. J. Phys. Chem. B, 108, 10736-10742 (2004)]. Recently, Higuchi et al. [Higuchi, M., Katayama, K., Azuma, Y., Yukawa, M. & Suhara, M. Synthesis of LiFePO₄ cathode material by microwave processing, J. Power Sources, 119-121, 258-261 (2003)] and Wang et al. [Wang, L., Huang, Y., Jiang, R. & Jia, D. Preparation and characterization of nano-sized LiFePO₄ by low heating solid-state coordination method and microwave heating, Electrochim Acta, 52, 6778-6783 (2007)] have pursued the microwave irradiation of mixtures consisting of the solid-state precursors to obtain LiFePO₄. One of the problems with such a process is the oxidation of Fe²⁺ to Fe³⁺, which could be controlled by conducting the microwave heating under an inert gas flow or by coating the raw materials with activated carbon or carbonaceous substance [Park, K. S., Son, J. T., Chung, H. T., Kim, S. J., Lee, C. H. & Kim, H. G. Synthesis of LiFePO₄ by co-precipitation and microwave heating, Electrochem Comm. 5, 839-842 (2003)]. However, while the former is cumbersome, the latter leaves a lot of carbon residue. More importantly, the initial discharge capacity was much lower (125 mAh/g) than the theoretical capacity (170 mAh/g) with some capacity fade. The present inventors invented a novel microwave-solvothermal approach in a non-aqueous solvent medium as well as an aqueous solvent medium to obtain well-defined nanoparticles of LiFePO₄ with high crystallinity in a short time (5-15 minutes) at temperatures as low as 300° C. without requiring any inert atmosphere or post annealing at elevated temperatures in reducing gas atmospheres. The use of nonaqueous medium helps to prevent the hydrolysis of Fe²⁺ to Fe³⁺ and formation of impurity phases containing Fe³⁺.

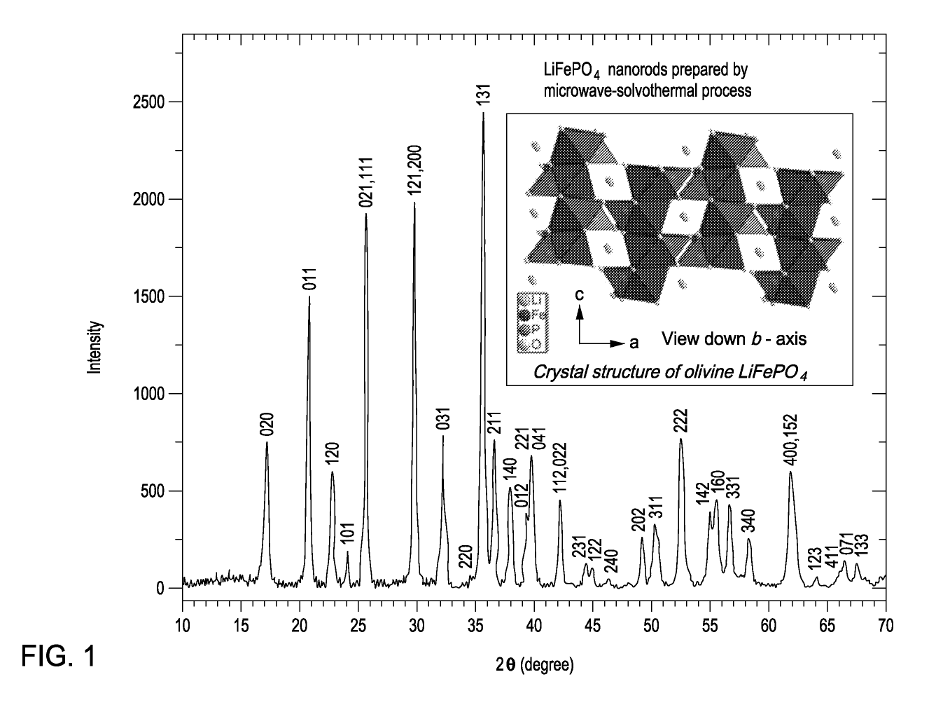

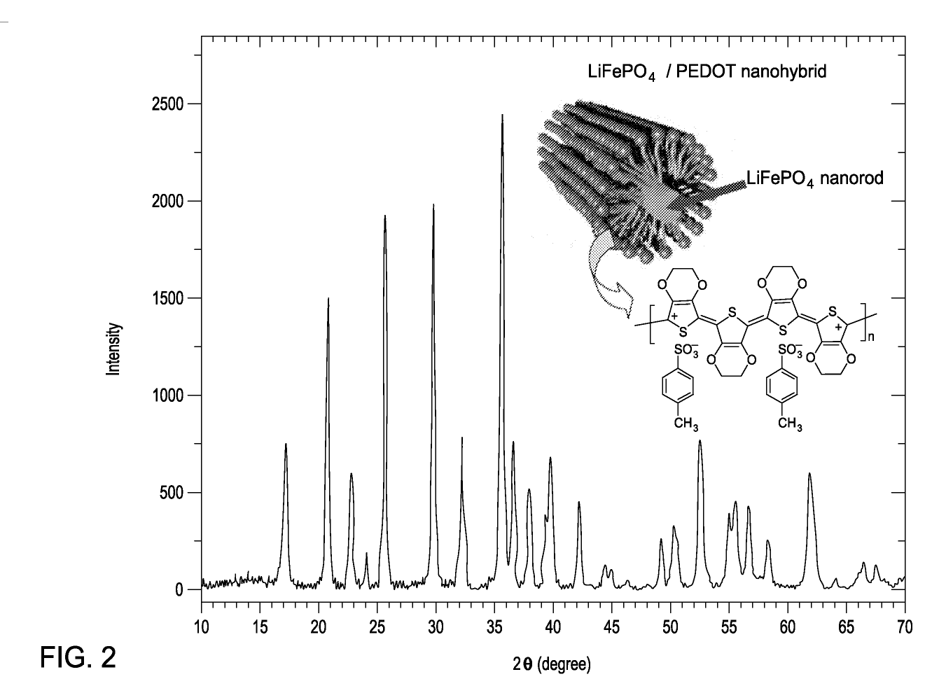

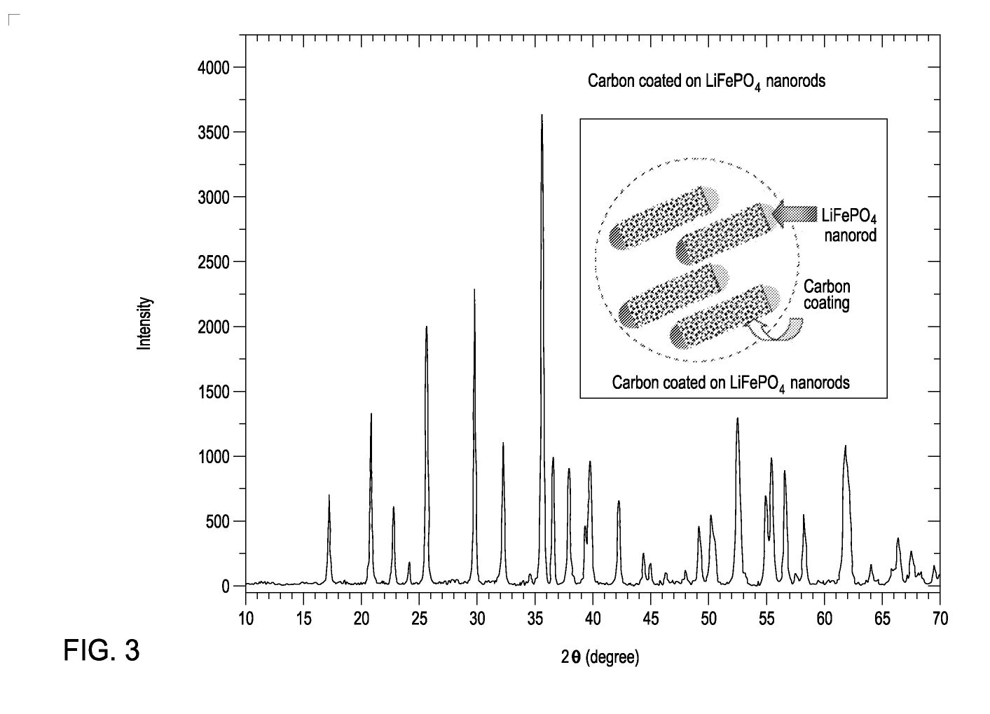

FIG. 1 is an image of the XRD patterns of LiFePO₄ nanorods obtained by the microwave-solvothermal method and FIG. 2 is an image of the XRD patterns after encapsulating the LiFePO₄ nanorods within the mixed electronically and ionically conducting p-TSA doped poly(3,4-ethylenedioxythiophene) (PEDOT) to form an organic-inorganic nanohybrid. The crystal structure of LiFePO₄ and PEDOT coated LiFePO₄ are also indicated. FIG. 3 is an image of the XRD pattern of LiFePO₄ coated with carbon by firing at 700° C. for 1 hour.

The use of a highly viscous, high boiling tetraethylenegycol (TEG) as a non-aqueous solvent provides a reducing environment to prevent the oxidation of Fe²⁺ and offers phase-pure nanocrystalline LiFePO₄ free from water contamination. In addition, TEG acts as a stabilizer, limiting particle growth and prohibiting agglomeration. The XRD pattern shown in FIG. 1 demonstrates the formation of highly crystalline LiFePO₄ without any detectable impurity phases such as Li₃PO₄ or Li₃Fe₂(PO₄)₃, which often appear in the traditional high temperature (800° C.) synthesis and microwave irradiated solid-state reaction methods [Higuchi, M., Katayama, K., Azuma, Y., Yukawa, M. & Suhara, M. Synthesis of LiFePO₄ cathode material by microwave processing, J. Power Sources, 119-121, 258-261 (2003)]. All the reflections in FIG. 1 could be indexed on the basis of an orthorhombic olivine-type structure, and Rietveld refinement of the XRD data with the Pnma space group gives a=10.320(1), b=6.000(1), and c=4.697(1) Å, which are in good agreement with the literature values [Andersson, A. S., Kalska, B., Häggström, L. & Thomas, J. O. Lithium extraction/insertion in LiFePO₄: an X-ray diffraction and Mössbauer spectroscopy study, Solid State Ionics, 130, 41-52 (2000)]. The analysis of the XRD data with the Scherrer equation indicated an average crystallite size value of about 42 nm.

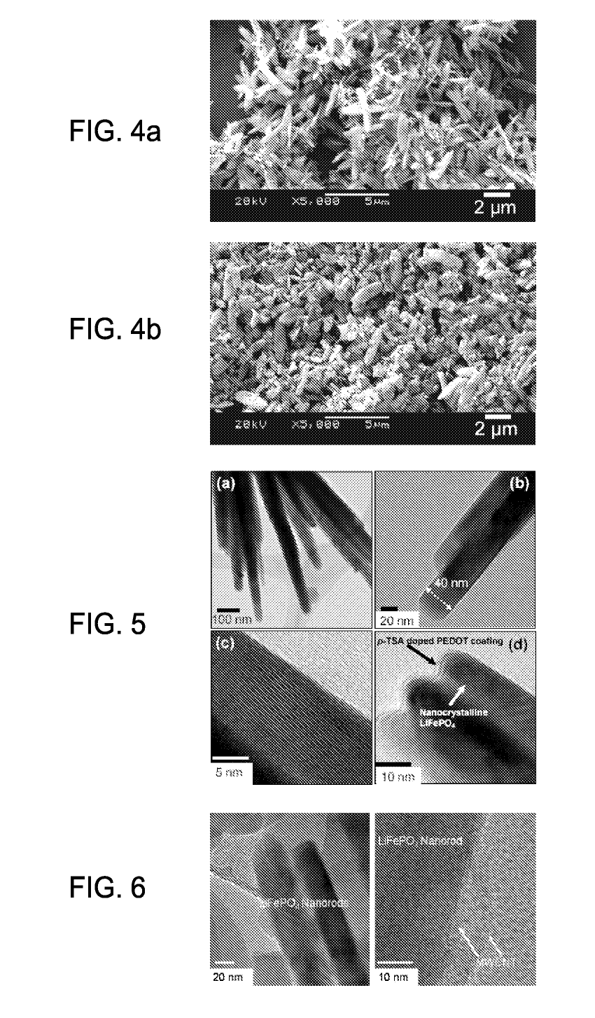

FIG. 4A is an SEM images of LiFePO₄ prepared by microwave-solvothermal process that has a nanoflower-like morphology and FIG. 4B is an SEM image after encapsulating the LiFePO₄ nanorods at room temperature within the electronically and ionically conducting doped poly(3,4-ethylenedioxythiophene) (PEDOT) to form an organic-inorganic nanohybrid.

FIGS. 5A, 5B and 5C are TEM images of LiFePO₄ nanorods prepared by the microwave-solvothermal method, and FIG. 5D shows the LiFePO₄ nanorods encapsulated within the p-TASA doped PEDOT polymer. The nanocrystals show relatively uniform rod-like morphology with an average width of 40 nm and a length of few microns with a narrow size distribution.

The high resolution transmission electron microscopy (HRTEM) images shown in FIGS. 5B and 5C reveal well-defined crystalline nanorod morphology. The microstructure indicates a relatively uniform rod like morphology with an average width of 40 nm and a length of few microns and a narrow particle size distribution. These results are consistent with the XRD crystallite size data. The HRTEM lattice fringe shown in FIG. 5C demonstrates the high crystalline nature of LiFePO₄ prepared by the microwave-solvothermal method. The highly crystalline nanorods obtained by the microwave-solvothermal method in a short time is appealing as most of the literature methods tend to produce poorly crystalline nanoparticles in the as-prepared stage or much larger size submicron particles following the post-heating process used to improve crystallinity and achieve carbon coating. Energy dispersive spectroscopic analysis of the LiFePO₄ nanocrystals indicated a Fe:P ratio of 1:1. FIG. 6 shows TEM images of LiFePO₄ after encapsulating by electronically conducing multi-walled carbon nanotubes (MWCNT) at room temperature

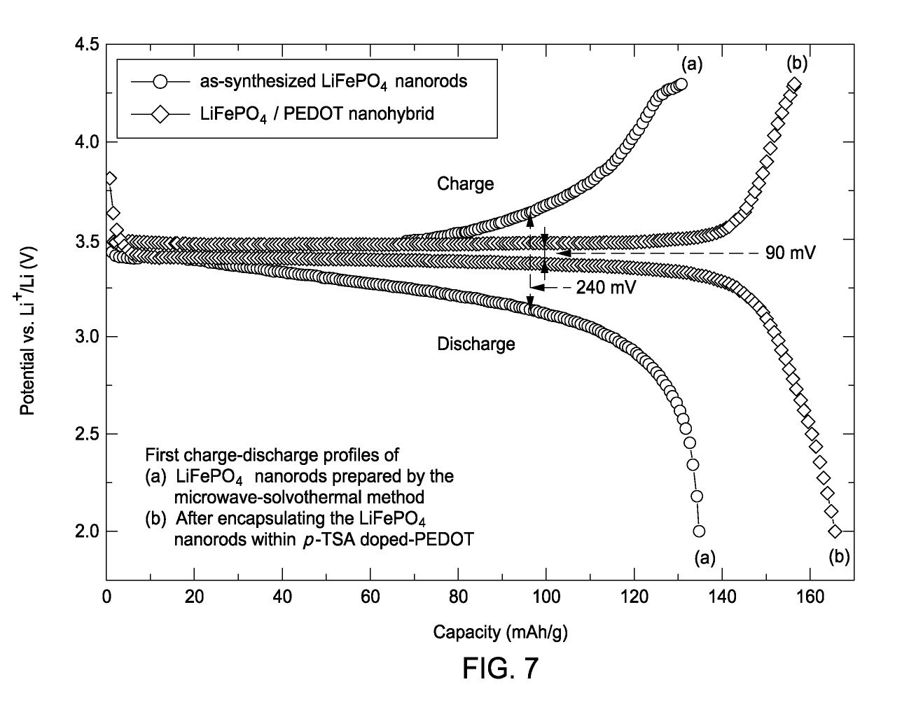

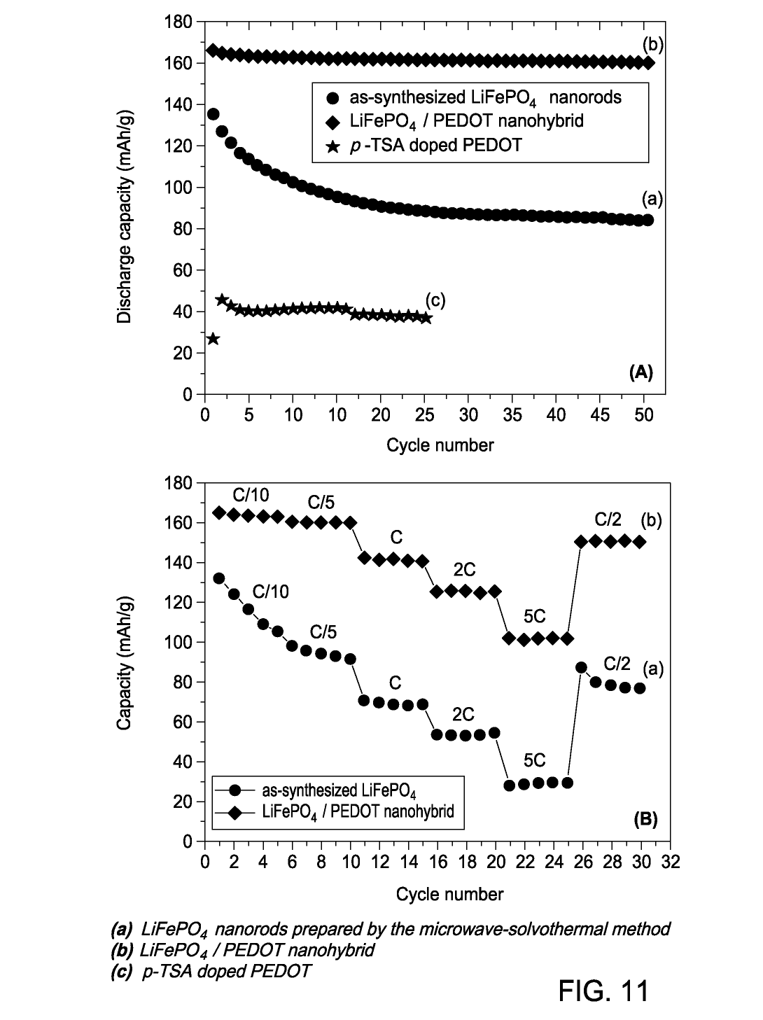

FIG. 7 is a plot comparing the first charge-discharge profiles of LiFePO₄ nanorods prepared by the microwave-solvothermal method and after encapsulating the LiFePO₄ nanorods within doped-PEDOT at C/15 rate between 4.3 and 2.0 V. The inset shows the corresponding cycle life data. FIG. 7 and FIG. 11(a) show the first charge-discharge profile and cyclability of the LiFePO₄ sample prepared by the microwave-solvothermal method. The as-prepared sample exhibits a discharge capacity of 135 mAh/g at C/15 rate in the voltage range of 2.0-4.3 V with a significant voltage difference between the charge and discharge curves and capacity fade.

Recognizing that the polarization loss could be due to the lack of adequate electronic and ionic conductivity and to avoid any high temperature post-annealing process normally involved with carbon coating, in one embodiment the present invention focuses on an ambient temperature coating of the LiFePO₄ nanorods with an electronically and ionically conducting polymer. Poly (3,4-ethylenedioxythiophene) (PEDOT) is an attractive conducting polymer due to its high environmental stability, superior thermal stability, redox behavior over a wide range of potentials, and high electronic conductivity in its doped state compared to other commonly available conducting polymers [Han, M. G & Armes, S. P. Synthesis of poly (3,4-ethylenedioxythiophene)/Silica Colloidal Nanocomposites. Langmuir, 19, 4523-4526 (2003)]. It has also been demonstrated that doped PEDOT (e.g. poly (styrene-4-sulponate) doped PEDOT) has mixed electronic as well as ionic conductivity [Li, G & Pickup, P. G. Ion transport in poly (3,4-ethylenedioxythiophene)-poly(styrene-4-sulfonate) composite, Phys. Chem. Chem. Phys., 2, 1255-1260 (2000)].

The synergistic effects that could be provided by the electrochemically active PEDOT make it a promising candidate to be used as an electronically and ionically conductive additive for energy storage applications such as lithium batteries and supercapacitors [Vadivel Murugan, A., Viswanath, A. K., Gopinath, C. S., & Vijayamohanan, K. Highly efficient organic-inorganic poly (3,4-ethylenedioxythiophene)—molybdenum trioxide nanocomposite electrodes for electrochemical supercapacitor. J. Appl. Phys, 100, 0743191-0743193 (2006)]. Moreover, while carbon coating by the high temperature post-annealing processes can result in non-continuous coating of the LiFePO₄ particles, the use of an electronically conducting polymer like PEDOT with better wetting properties can provide uniform coating.

Accordingly, the LiFePO₄ nanorods obtained by the microwave-solvothermal process were coated with 8 wt. % p-toluene sulfonic acid (p-TSA) doped PEDOT at ambient temperature without any post annealing to obtain an organic-inorganic nanohybrid. The XRD pattern of the LiFePO₄-PEDOT nanohybrid shown in FIG. 2 indicates that the nano-crystalline nature of LiFePO₄ is maintained without any diffraction peaks for PEDOT, possibly due to its low content. The TEM image of the LiFePO₄-PEDOT nanohybrid shown in FIG. 5D reveals the encapsulation of the LiFePO₄ nanorods (dark region) by PEDOT (grayish transparent region). The encapsulating doped PEDOT provides an electronically and ionically conducting nano-network without blocking the lithium ion diffusion between the adjacent LiFePO₄ nanorods.

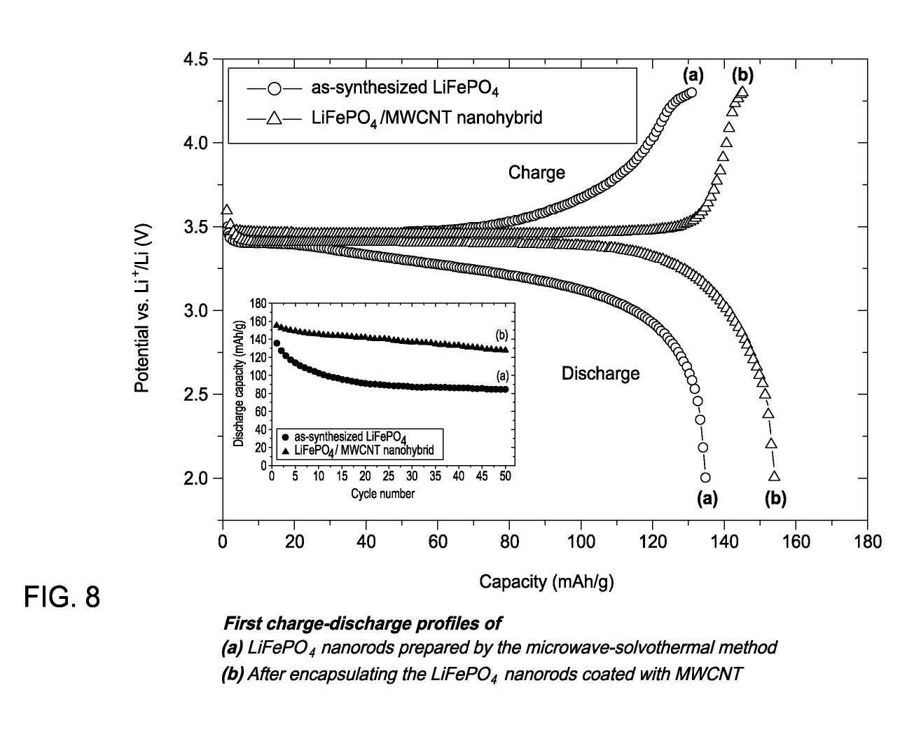

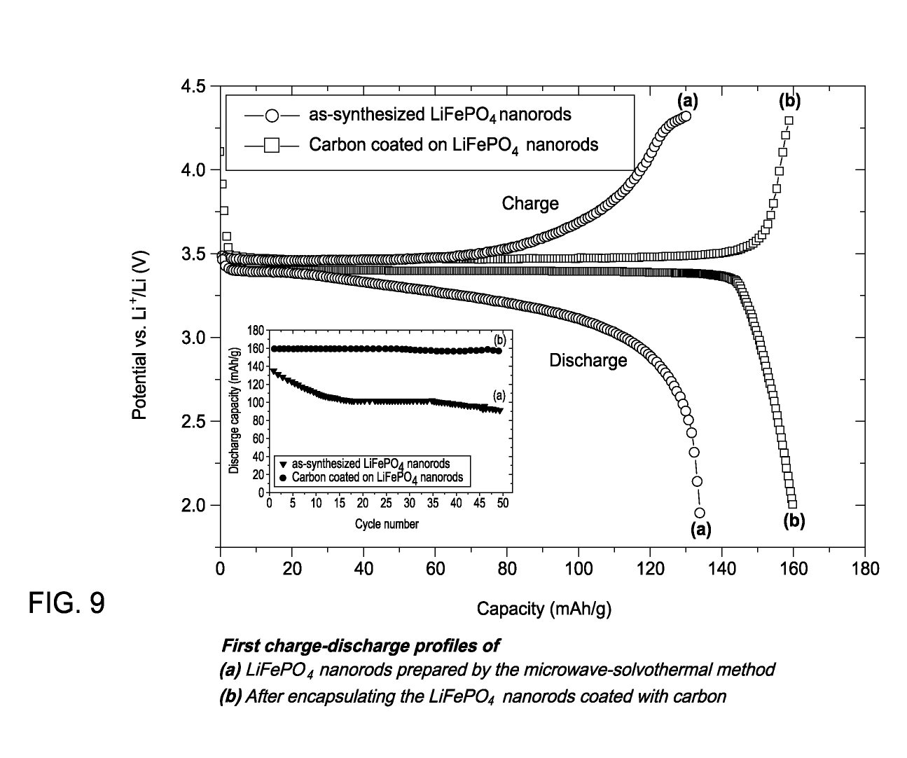

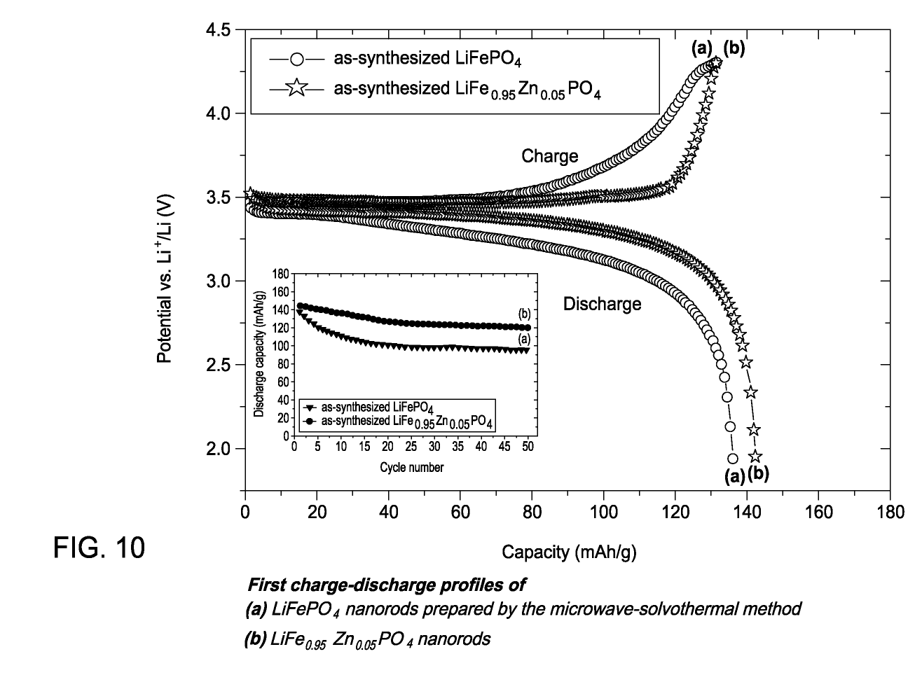

FIG. 8 is a plot comparing the first charge-discharge profiles of LiFePO₄ nanorods prepared by the microwave-solvothermal method and after encapsulating the LiFePO₄ nanorods within multi-walled carbon nanotubes (MWCNT) at C/15 rate between 4.3 and 2.0 V. The inset shows the corresponding cycle life data. FIG. 9 is a plot comparing the first charge-discharge profiles of LiFePO₄ nanorods prepared by the microwave-solvothermal method and after encapsulating the LiFePO₄ nanorods within carbon at C/15 rate between 4.3 and 2.0 V. The inset shows the corresponding cycle life data. FIG. 10 is a plot comparing the first charge-discharge profiles of LiFePO₄ and LiFe_{0.95}Zn_{0.05}PO₄ nanorods prepared by the microwave-solvothermal method at C/15 rate between 4.3 and 2.0 V. The inset shows the corresponding cycle life data.

FIG. 11A is a graph comparing the cyclability and FIG. 11B is a graph comparing the rate capability of LiFePO₄ nanorods synthesized by the microwave-solvothermal method and after encapsulating the LiFePO₄ nanorods within p-TSA doped-PEDOT. The cyclability of doped PEDOT is also shown in FIG. 11A.

The charge-discharge profile shown in FIG. 7 reveals that the LiFePO₄-PEDOT nanohybrid exhibits a high discharge capacity (166 mAh/g) close to that of the theoretical value (170 mAh/g) with little difference between the charge and discharge curves. The data in FIG. 11A demonstrate excellent cyclability with about 3% fade in 50 cycles for the LiFePO₄-PEDOT nanohybrid. The remarkable electrochemical performance of the LiFePO₄-PEDOT nanohybrid compared to as-synthesized LiFePO₄ can be attributed to the mixed electronic-ionic conductivity of PEDOT. More importantly, the doped PEDOT exhibits a capacity of about 40 mAh/g with good cyclabilty in the voltage range of 2.5-4.0 V vs Li⁺/Li as seen in FIG. 11A, illustrating the redox behavior and the synergistic effect that could be provided by PEDOT compared to the redox inactive carbon coating.

FIG. 11B is a graph that compares the rate (power) capability of pristine LiFePO₄ and the LiFePO₄-PEDOT nanohybrid at C/10 to 5C rates. The LiFePO₄-PEDOT nanohybrid exhibits superior power capability compared to the pristine LiFePO₄. The significantly improved electrochemical performances of the LiFePO₄-PEDOT nanohybrid compared to the pristine LiFePO₄ is due to the synergistic effects provided by the electronically and ionically conducting doped PEDOT. The results demonstrate a cost effective, rapid method to manufacture high performance phospho-olivine cathodes for high volume applications such as hybrid electric vehicles and plug-in hybrid vehicles.

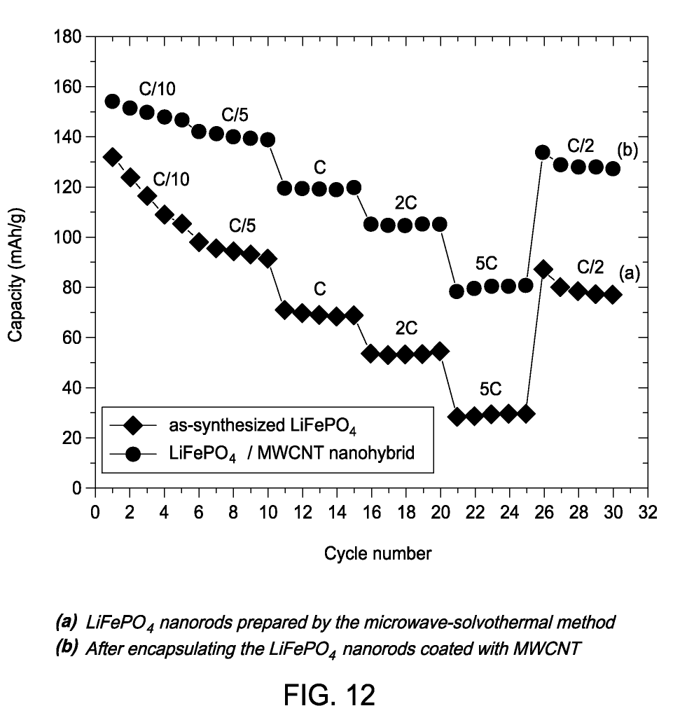

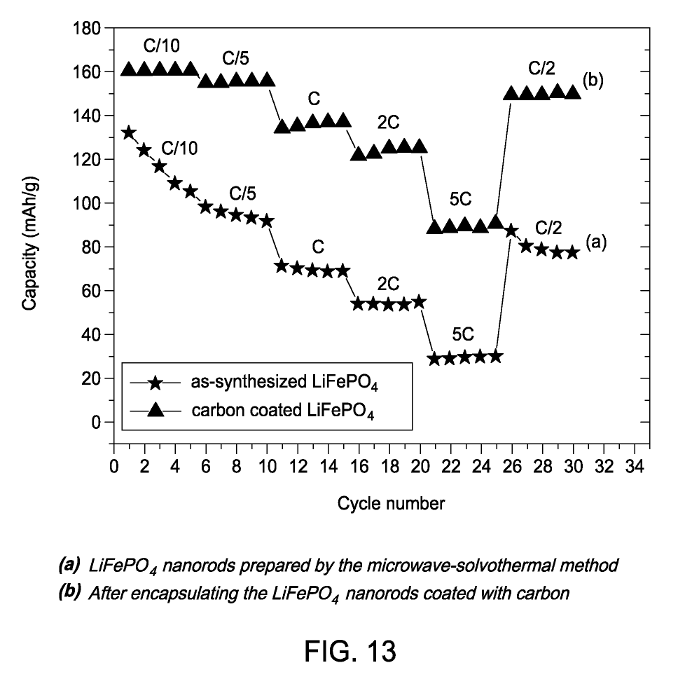

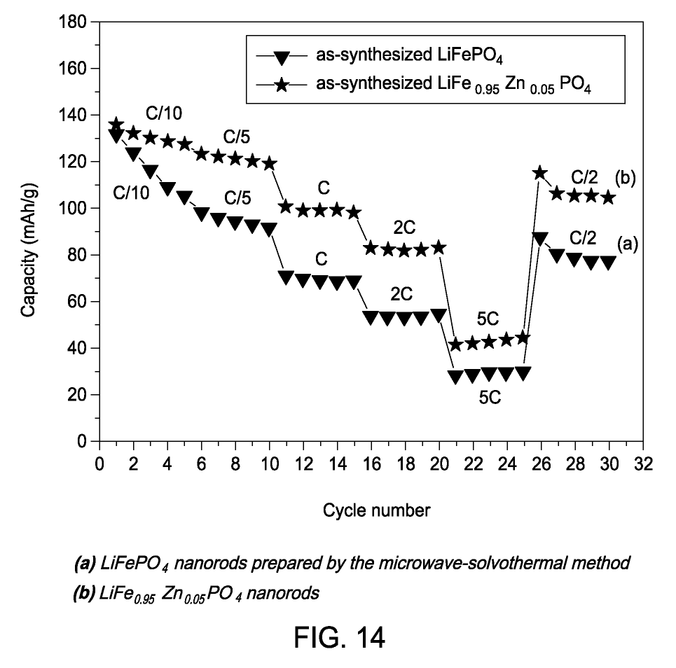

FIG. 12 is a plot comparing the rate capability of LiFePO₄ nanorods prepared by the microwave-solvothermal method and after encapsulating the LiFePO₄ nanorods within multi-walled carbon nanotubes (MWCNT). FIG. 13 is a plot comparing the rate capability of LiFePO₄ nanorods prepared by the microwave-solvothermal method and after encapsulating the LiFePO₄ nanorods within carbon. FIG. 14 is a plot comparing the rate capability of pristine LiFePO₄ and LiFe_{0.95}Zn_{0.05}PO₄ electrodes.

Method of microwave-solvothermal synthesis of nano-LiFePO₄: Lithium hydroxide (Fisher) and iron (II) acetate (Alfa Aesar) were first dissolved in tetraethyleneglycol (TEG) (ACROS-Organics), and H₃PO₄ (85%, Fisher) was then added dropwise to the TEG solution at room temperature to realize a Li:Fe:P molar ratio of 1:1:1. The homogeneous, yellow gel formed was transferred into quartz vessel and placed on a turntable for uniform heating in an Anton Paar microwave irradiated synthesis system (Synthos-3000). The system was operated at a frequency of 2.45 GHz and a power of 1,000 W, and the temperature was raised to 300° C. and maintained for 15 minutes. These vessels were transparent to microwave radiation, so the contents in these vessels could be heated solvothermally. When the reaction mixture was exposed to microwave radiation, the microwave induced rotation of the dipoles within the liquid force the polar molecules to align and relax in the field of oscillating electromagnetic radiations and cause the liquid to become hot. Thus, the heat produced within the liquid is not transferred from the vessel unlike in other conventional systems. Precipitation of LiFePO₄ took place inside the reactor during this solvothermal process, and the reactor was cooled to room temperature after the solvothermal process. The supernatant TEG solvent was carefully decanted, and the resulting cream-white LiFePO₄ nanocrystals were washed repeatedly by centrifugation with a mixture of acetone and methanol until the washings were colorless to ensure the complete removal of TEG. The obtained powder was then dried at 80° C. for 1 hour in a vacuum oven.

Synthesis of p-toluenesulfonic acid (p-TSA) doped poly (3,4-ethylenedioxythiophene): The electronically and ionically conductive p-TSA doped poly(3,4-ethylenedioxythiophene) (PEDOT) was prepared via oxidative chemical polymerization. Since the 3,4-ethylenedioxythiophene (EDOT) monomer (Aldrich) is only slightly soluble in water and exhibits high oxidation potential for the polymerization to occur easily, the solubility of EDOT was controlled by mixing methanol with de-ionized water and p-toluenesulfonic acid (p-TSA), (Spectrum). The p-TSA organic acid is known as a good dopant for highly conducting PEDOT and it confers an increased solubility of EDOT in water, possibly due to the enhanced protonation of EDOT. Appropriate quantities of p-TSA and EDOT monomer were added to a mixture of methanol and water (1:1 by volume), and the polymerization reaction was initiated by adding under constant stirring the oxidant, ammonium persulfate (Fisher) dissolved in minimum amount of water; the molar ratio of EDOT and ammonium persulfate was 1:1. After 24 hours of the polymerization reaction at 30° C., the supernatants were carefully decanted, and the resulting dark blue conducting PEDOT was washed several times with a 1:1 mixture of methanol and water until the washings were colorless to ensure the complete removal of the unreacted monomer and oxidant. The p-TSA doped PEDOT thus obtained was then dispersed in ethanol to form a colloidal solution.

Synthesis of LiFePO₄-doped PEDOT nanohybrid: An appropriate amount of the as-synthesized LiFePO₄ nanocrystals were mixed with ethanol and ultrasonicated for a few minutes. The cream-white colored colloidal solution formed was then mixed with the dark blue colored colloidal solution containing p-PTSA doped PEDOT by magnetic stirring for a few minutes at room temperature to ensure complete encapsulation of the LiFePO₄ nanocrystals within the p-PTSA doped PEDOT to form an organic-inorganic nanohybrid, which was then dried in a vacuum oven at 80° C. The weight ratio of LiFePO₄ and p-PTSA doped PEDOT was 92:8.

Materials characterization: The XRD data were collected with a Philiphs X-ray diffractometer and Cu Kα radiation. The TEM data were collected with a JEOL JEM-2010F equipment by dispersing an ethanol suspension of the samples onto a holy carbon grid. Electrochemical performances were evaluated with CR2032 coin cells at 4.3-2.0 V for LiFePO₄ and LiFePO₄-PEDOT hybrid and at 4.0-2.5 V for PEDOT with an Arbin battery cycler. The coin cells were fabricated with the LiFePO₄ or LiFePO₄-PEDOT cathode, metallic lithium anode, 1 M LiPF₆ in 1:1 diethyl carbonate/ethylene carbonate electrolyte, and Celgard polypropylene separator. The cathodes were prepared by mixing 75 weight % active materials with 20 wt % conductive carbon and 5 wt % polytetrafluoroethylene (PTFE) binder, rolling the mixture into thin sheets, and cutting into circular electrodes of 0.64 cm² area. The electrodes typically had an active material content of about 7 mg, and were dried under vacuum at 80° C. for more than 3 hours before assembling the cells in an argon-filled glovebox.

### EXAMPLE 1

The present invention provides a simple, single step novel process based on microwave irradiated solvothermal reaction for the preparation of nanostructured phospho-olivine cathode materials for lithium secondary batteries. LiₓM_{y}PO₄ where 0<x≦1.2, 0.8≦y≦1.2, and M is at least one element selected from the group consisting of Fe, Mn, Co, Ti, Ni, Cu, V, Mo, Zn, Mg, Cr, Al, Ga, B, Zr, and Nb or combination thereof. The process involves first the dissolution of lithium hydroxide and metal salts like acetates, nitrates, or chlorides in tetraethyleneglycol, followed by an addition of H₃PO₄ drop-wise at room temperature so that the molar ratio of Li:M:P in the precursor solution is 1:1:1. The homogeneous, transparent yellow gel formed was transferred into quartz vessel and placed on a turntable for uniform heating in an Anton Paar microwave irradiated synthesis system (Synthos-3000). The system was operated at a frequency of 2.45 GHz and a power of 1,000 W, and the temperature was raised to 300° C. and maintained for 15 minutes. These vessels were transparent to microwave radiation, so the contents in these vessels could be heated solvothermally.

When the reaction mixture was exposed to microwave radiation, the microwave induced rotation of the dipoles within the liquid forced the polar molecules to align and relax in the field of oscillating electromagnetic radiations and caused the liquid to become hot. Thus, the heat produced within the liquid is not transferred from the vessel unlike in other conventional systems. Precipitation of LiFePO₄ took place inside the reactor during this solvothermal process, and the reactor was cooled to room temperature after the solvothermal process. The supernatant TEG solvent was carefully decanted, and the resulting cream-white LiFePO₄ nanocrystals were washed repeatedly by centrifugation with a mixture of acetone and methanol until the washings were colorless to ensure the complete removal of TEG. The obtained powder was then dried at 80° C. for 1 hour in a vacuum oven and characterized by XRD, SEM, TEM, elemental analysis, and electrochemical measurements.

### EXAMPLE 2

The present invention provides a simple, single step novel process based on microwave irradiated solvothermal reaction for the preparation of nanostructured phospho-olivine cathode materials for lithium secondary batteries. Doped LiₓFe_{1-y}M_{y}PO₄, where 0<x≦1.2, 0<y≦1, and M is at least one element selected from the group consisting of Mn, Co, Ti, Ni, Cu, V, Mo, Zn, Mg, Cr, Al, Ga, B, Zr, and Nb was prepared by first dissolving lithium hydroxide and iron (II) and other metal salts like acetates, nitrates, and chlorides in tetraethyleneglycol, followed by adding H₃PO₄ drop-wise at room temperature so that the molar ratio of Li:Fe(M):P in the precursor solution is 1:1:1. The homogeneous, transparent yellow gel formed was transferred into a quartz vessel and placed on a turntable for uniform heating in an Anton Paar microwave irradiated synthesis system (Synthos-3000). The system was operated at a frequency of 2.45 GHz and a power of 1,000 W, and the temperature was raised to 300° C. and maintained for 15 minutes.

These vessels were transparent to microwave radiation, so the contents in these vessels could be heated solvothermally. When the reaction mixture was exposed to microwave radiation, the microwaves induced rotation of the dipoles within the liquid forced the polar molecules to align and relax in the field of oscillating electromagnetic radiations and caused the liquid to become hot. Thus, the heat produced within the liquid is not transferred from the vessel unlike in other conventional systems. Precipitation of LiFePO₄ took place inside the reactor during this solvothermal process, and the reactor was cooled to room temperature after the solvothermal process. The supernatant TEG solvent was carefully decanted, and the resulting cream-white LiFePO₄ nanocrystals were washed repeatedly by centrifugation with a mixture of acetone and methanol until the washings were colorless to ensure the complete removal of TEG. The obtained powder was then dried at 80° C. for 1 hour in a vacuum oven and characterized by XRD, SEM, TEM, elemental analysis, and electrochemical measurements.

### EXAMPLE 3

An electronically and ionically conductive polymer such as polyaniline, polypyrrole, polythiophene, and substituted poly (3,4-ethylenedioxythiophene) (PEDOT) was prepared via an oxidative chemical polymerization route. Since the 3,4-ethylenedioxythiophene (EDOT) monomer (Aldrich) is only slightly soluble in water and

Appropriate quantities of p-TSA and EDOT monomer were added to a mixture of methanol and water (1:1 by volume), and the polymerization reaction was initiated by adding under constant stirring the oxidant, ammonium persulfate dissolved in minimum amount of water; the molar ratio of EDOT and ammonium persulfate was 1:1. After 24 hours of the polymerization reaction at 30° C., the supernatants were carefully decanted, and the resulting dark blue conducting PEDOT was washed several times with a 1:1 mixture of methanol and water until the washing was colorless to ensure the complete removal of the unreacted monomer and oxidant. The p-TSA doped PEDOT thus obtained was then dispersed in ethanol to form a colloidal solution.

The nanostructured LiₓM_{y}PO₄ and LiₓFe_{1-y}M_{y}PO₄ powders obtained by the microwave-solvothermal method were then encapsulated within the electronically conductive polymer or doped polymer (polypyrrole, polyaniline, polythiophene, poly-p-phenylene vinylene, PEDOT and their substituted derivatives) to obtain nanohybrids consisting of LiₓM_{y}PO₄ or LiₓFe_{1-y}M_{y}PO₄ and the conductive polymer. The amount of the electronically conducting polymer varies from 0.1 wt % to 50 wt %. The obtained powder was characterized by XRD, SEM, TEM, elemental analysis, and electrochemical measurements.

### EXAMPLE 4

The nanostructured LiₓM_{y}PO₄ and LiₓFe_{1-y}M_{y}PO₄ powders obtained by the microwave-solvothermal method were then encapsulated within electronically conducting multi-walled carbon nanotubes (MWCNT). MWCNT was refluxed with nitric acid at 80° C. for 10 hours and washed with distilled water until the pH value of the filtrate reached 7. MWCNT was ultrasonically dispersed in toluene for a few minutes, the pristine LiₓM_{y}PO₄ or LiₓFe_{1-y}M_{y}PO₄ was added under constant magnetic stirring, and dried in an oven at 80° C. to form a LiFePO₄-MWCNT or LiₓFe_{1-y}M_{y}PO₄-MWCNT nanohybrid. The amount of MWCNT varies from 0.1 wt % to 50 wt %.

### EXAMPLE 5

The nanostructured LiₓM_{y}PO₄ and LiₓFe_{1-y}M_{y}PO₄ powders obtained by the microwave-solvothermal method were then encapsulated within electronically conducting carbon. The nanostructured LiₓM_{y}PO₄ or LiₓFe_{1-y}M_{y}PO₄ powders were mixed with an appropriate amount of sucrose solution in ethanol and the dried solid product was heated at 700° C. for 1 hour in 5% hydrogen and about 95% argon atmosphere to form a LiFePO₄-carbon or LiₓFe_{1-y}M_{y}PO₄-carbon nanohybrid. The amount of carbon varies from 0.1 weight % to 50 weight %.

### EXAMPLE 6

The electrochemical performances were evaluated with CR2032 coin cells between 4.3 and 2.0 V. The coin cells were fabricated with the phospho-olivine based cathode, metallic lithium anode, 1 M LiPF₆ in 1:1 diethyl carbonate/ethylene carbonate electrolyte, and a Celgard polypropylene separator. The active material in the cathode was nanostructured LiₓM_{y}PO₄ or LiₓFe_{1-y}M_{y}PO₄ or after encapsulating LiₓM_{y}PO₄ or LiₓFe_{1-y}M_{y}PO₄ within an electronically conducting polymer, MWCNT, or carbon. The cathodes were prepared by mixing 75 weight % active materials with 20 weight % conductive carbon and 5 weight % polytetrafluoroethylene (PTFE) binder, rolling the mixture into thin sheets, and cutting into circular electrodes of 0.64 cm2 area. The electrodes typically had an active material content of about 7 mg, and were dried under vacuum at 80° C. for more than 3 hours before assembling the cells in an argon-filled glovebox.

The present inventors discovered a microwave assisted synthesis approach to shorten the reaction time to a few minutes with significant energy savings while controling the chemical composition, crystallite size, and particle shape.

The conventional hydrothermal process involves an extremely long reaction time (e.g., between 5 and 12 hours) to synthesize LiFePO₄ and in-situ coating of carbon on LiFePO₄ using carbon precursors during the hydrothermal process have been unsucessful producing compositions with low rate capabilities. [K. Shiraishi, K. Dokko, K. Kanamura J. Power Sources 2005, 146, 555; S. Franger, F. Le Cras, C. Bourbon and H. Rouanlt, J. Power Sources, 2003, 119-121, 252; S. Tajimi, Y. Ikeda, K. Uematsu, K. Toda and M. Sato, Solid State Ionics, 2004, 175, 287; J. Lee and A. S. Teja, Mater. Lett., 2006, 60, 2105; K. Dokko, S. Koizumi, K. Sharaishi and K. Kananura, J. Power Sources, 2007, 165, 656; G. Meligrana, C. Gerbaldi, A. Tuel, S. Bodoardo, N. Penazzi, J. Power Sources 2006, 160, 516; B. Jin, H.-B. Gu, Solid State Ionics 2008, 178, 1907; E. M. Jin, B. Jin, D.-K. Jun, K.-H. Park, H.-B. Gu, K.-W. Kim, J. Power Sources 2008, 178, 801; K. Dokko, K. Shiraishi, K. Kanamura, J. Electrochem. Soc., 2005, 152,11 A2199.]

Recently, Beninati [S. Beninati, L. Damen and M. Mastragostino, J. Power Sources, 2008, 180, 875] and Wang [L. Wang, Y. Huang, R. Jiang and D. Jia, Electrochim Acta, 2007, 52, 6778] reported the microwave synthesis of LiFePO₄ by irradiating a mixture of the solid-state raw materials and microwave absorbants such as carbon or carbonaceous substance in a microwave oven. However, the compositions produced were questionable as the initial discharge capacity of the sample obtained was much lower (125 mAh/g) than the theoretical value (170 mAh/g), and they were unable to control the particle size with the microwave irradiated solid state reaction.

The present inventors developed a novel facile, one pot synthesis of carbon coated LiFePO₄ nanorods within a short time (e.g., 15 minutes) by a microwave assisted hydrothermal (MW-HT) method. The instant method uses microwave irradiation and the hydrothermal effect to prepare nanocrystalline materials. [I. Bilecka, I. Djerdj and M. Niederberger, Chem. Commun., 2008, 886; X. Hu and J. C. Yu, Adv. Funct. Mater., 2008, 18, 880; A Vadivel Murugan, A. Kasi Viswanath, B. A. Kakade, V. Ravi and V Saaminathan, Appl. Phys. Lett., 2006, 89, 123120.] The instant method offers a drastic reduction in synthesis time (e.g., about 15 minutes) compared to the time consuming (e.g., between 5 and 24 hours), traditional refluxing [D.-H. Kim and J. Kim, Electrochem. Solid State Lett., 2006, 9, A439] or heating in a furnace or autoclave. [S. Franger, F. Le Cras, C. Bourbon and H. Rouanlt, J. Power Sources, 2003, 119-121, 252; J. Lee and A. S. Teja, Mater. Lett., 2006, 60, 2105] The instant compositions provide an enhancement in electronic conductivity by a simultaneous in situ coating of a thin nanolayer of carbon on the LiFePO₄ nanorods via a hydrothermal carbonization of glucose during the synthesis process. The hydrothermal carbonization of glucose not only acts as a reducing agent and offers an in-situ coating of carbon on LiFePO₄, but also helps to prevent the growth or agglomeration of the LiFePO₄ nanoparticles during the hydrothermal process. The LiFePO₄/C nanocomposite thus obtained by the microwave-hydrothermal process shows uniform carbon coating with high rate capability and excellent cyclability.

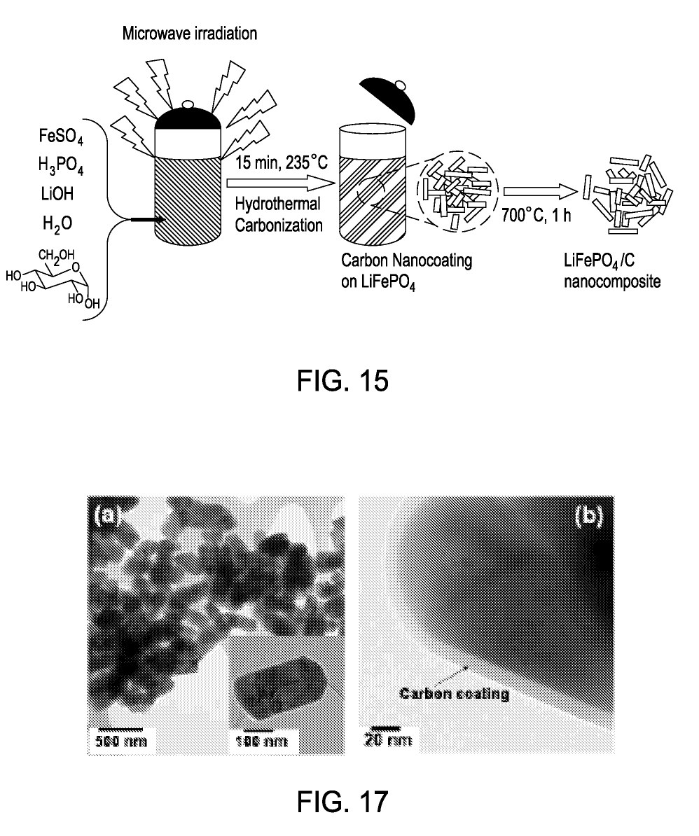

FIG. 15 is a schematic representation of the microwave-hydrothermal process employed to prepare the LiFePO₄/C nanocomposite. A mixed aqueous solution 10 containing LiOH (Fisher), H₃PO₄ (85%, Fisher), and glucose was first stirred for a few minutes; glucose (0.5 mol L⁻¹) was added as an in situ reducing agent to minimize the oxidation of Fe²⁺ to Fe³⁺ and to provide the carbon coating on LiFePO₄. An aqueous solution of FeSO₄.7H₂O (Spectrum-Chemicals) was then added into the above mixture so that the Li:Fe:P molar ratio was 3:1:1. The reaction mixture with a cream colored white precipitate was transferred into a quartz vessel 12, sealed, and heated at about 235° C. for about 15 minutes under the microwave-hydrothermal condition. These quartz vessel was transparent to microwave radiation 14, so the reaction mixture with a polar solvent in the vessel could be heated hydrothermally. The vessel 12 was then cooled to room temperature, the black colored product 16 was isolated by filtration, washed with deionized water and absolute ethanol, and dried in a vacuum oven at about 80° C. The resultant in situ carbon coated LiFePO₄ powder 18 was subsequently carbonized under a flowing 2% H₂-98% Ar atmosphere at about 700° C. for a short duration of about 1 hour to produce product 20. The formation of a black product 20 confirms the coating of carbon on LiFePO₄ during the microwave-hydrothermal process.

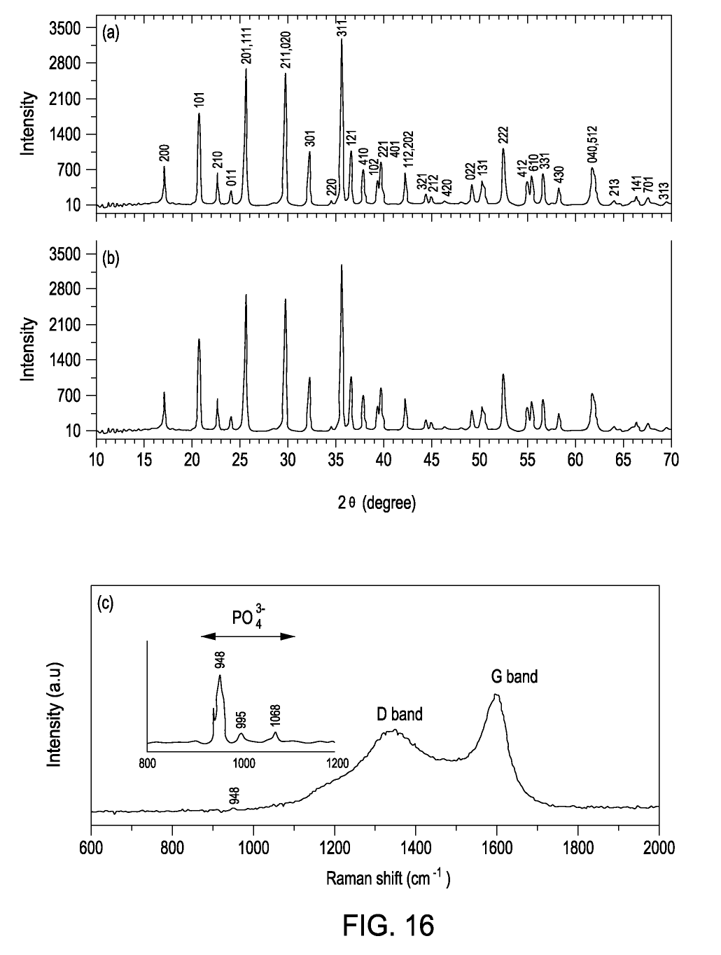

FIGS. 16A and 16B are plots of the XRD patterns of synthesized LiFePO₄/C nanocomposite obtained by the facile one step microwave-hydrothermal process (about 15 minutes) and the LiFePO₄/C nanocomposite after heating at 700° C. for about 1 hour in 2% H₂-98% Ar, respectfully. FIG. 16C is a Raman spectrum of the LiFePO₄/C nanocomposite. FIG. 16A is a plot of the XRD pattern of the LiFePO₄/C nanocomposite obtained by the microwave irradiated hydrothermal method. The sharp diffraction peaks without any impurity phases indicate the formation of a highly crystalline, phase pure LiFePO₄ at a low temperature of 235° C. in a short reaction time of 15 minutes by the novel microwave-hydrothermal process employed here. In order to improve the structural order of the carbon coating, the as-synthesized LiFePO₄/C nanocomposite was further heated in an inert atmosphere at about 700° C. for about 1 hour, and the corresponding XRD pattern is shown in FIG. 16B. All the reflections in FIGS. 16A and 16B could be indexed on the basis of an orthorhombic olivine-type structure with the Pnma space group and lattice parameter values of a=10.321(1), b=6.001(1), and c=4.696(1) Å, which are in good agreement with the literature values.² No reflections corresponding to carbon is seen due to its low content and/or its poor crystallinity. Thermogravimetric (TGA) analysis (not shown) further confirmed the carbon content in the LiFePO₄/C nanocomposit to be about 5 weight %.

The Raman spectrum in FIG. 16C shows the characteristic bands for both carbon and LiFePO₄, indicating the coating of carbon on LiFePO₄. The sharp band at 948 cm⁻¹ together with those at 995 and 1068 cm⁻¹ are attributed to the symmetric PO₄³⁻ stretching vibration of LiFePO₄ as shown in the inset of FIG. 16C. The band observed at 1607 cm⁻¹ corresponds to the graphite band (G-band), which is characteristic of a high degree of ordered structure in carbon materials.^{8b, c} On the other hand, the band observed around 1337 cm⁻¹ corresponds to a disorder-induced phonon mode (D-band) for disordered carbon materials. It is generally believed that the I_{D}/I_{G} value (the peak intensity ratio between the 1337 and 1607 cm⁻¹ peaks) provides a useful index for comparing the degree of crystallinity of various carbon materials,⁸ i.e., smaller the ratio of I_{D}/I_{G}, higher the degree of ordering in the carbon material. [M. S. Bhuvaneswari, N. N. Bramnik, D. Ensling, H. Ehrenberg and W. Jaegermann, J. Power Sources, 2008, 180, 553; Q. Wang,; H. Li,; L. Chen,; X. Huang, Carbon 2001, 39, 2211; M. S Dresselhaus, G. Dresselhaus, A. Jorio, A. G. Souza Filho and R. Saito, Carbon, 2002, 40, 2043; X. Sun and Y. Li, Angew. Chem. Int. Ed. 2004, 43, 597]. A smaller I_{D}/I_{G} ratio in FIG. 16C indicates a high degree of ordering in the carbon coated on LiFePO₄.

FIGS. 17A and 17B are TEM images of LiFePO₄/C nanocomposite. FIG. 17A is a TEM image of the LiFePO₄/C nanocomposite obtained by the microwave-hydrothermal method after heat treatment, illustrating the nanorod-like morphology. FIG. 17B is a high resolution TEM image of LiFePO₄/C, illustrating the thin carbon coating on LiFePO₄. The transmission electron microscopy (TEM) images of the carbon coated LiFePO₄ prepared by the microwave-hydrothermal process is shown in FIGS. 17A and 17B. The images demonstrate a well-defined, crystalline nanorod morphology with controlled size. The high resolution TEM image of the LiFePO₄/C nanocomposite shown in FIG. 17B contrasts the LiFePO₄ nanorods (dark region) from the carbon coating (white region). Typically, the carbon coating was found to be between about 5 and 12 nm while the core LiFePO₄ nanorod was found to have a diameter of around 225± about 6 nm. The crystallite dimensions was deduced from the TEM data for the LiFePO₄ nanorods before and after heat treatment at 700° C. for 1 hour, and the data suggest that the high temperature treatment does not change the crystallite size of LiFePO₄ as the carbon coating inhibits the crystallite growth normally encountered during high temperature heat treatment.

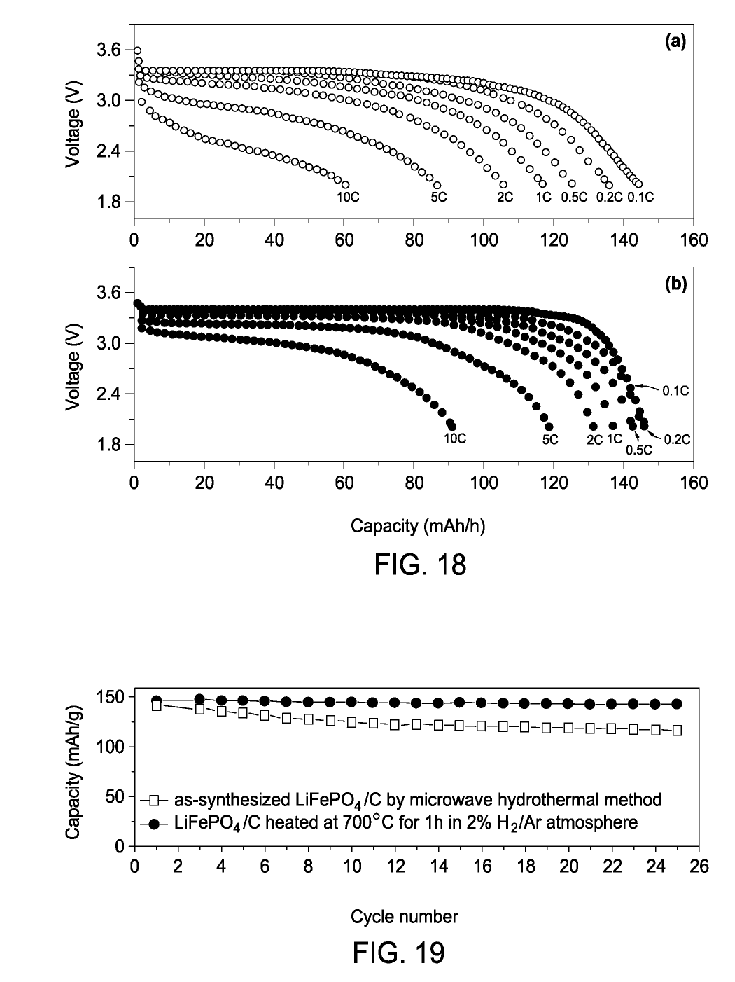

FIG. 18 shows the discharge profile collected at different C-rates (rate capability) and the cyclability of the as-synthesized LiFePO₄/C obtained by the microwave irradiated hydrothermal method and after annealing the LiFePO₄/C nanocomposite at 700° C. for 1 hour. FIGS. 18A and 18B are discharge profiles that relate the voltage and capacity of as-synthesized LiFePO₄/C nanocomposite obtained by the one step microwave-hydrothermal carbonization method and heat treating the LiFePO₄/C nanocomposite at 700° C. for 1 hour in 2% H₂-98% Ar atmosphere respectively. FIGS. 18A and 18B compare the rate capabilities of the as-synthesized LiFePO₄/C and the annealed LiFePO₄/C at 0.1C to 10C rates. The annealed LiFePO₄/C nanocomposites exhibit an initial discharge capacity 150 mAh/g at C/10 rate, which is 88% of the theoretical capacity. Although the first initial discharge capacity values of the as-synthesized (144 mAh/g) and annealed samples (150 mAh/g) do not differ much, the annealed LiFePO₄/C nanocomposite exhibits better rate capability compared to the as-synthesized LiFePO₄/C.

FIG. 19 is a graph of the discharge profiles that shows the cyclability of the as-synthesized LiFePO₄/C nanocomposite obtained by the microwave-hydrothermal method and after heat treating the LiFePO₄/C nanocomposite at 700° C. for 1 hour in 2% H₂-98% Ar atmosphere. The cyclability data in FIG. 19 reveal that while the as-synthesized LiFePO₄/C sample exhibits some capacity fade, the annealed sample exhibits excellent capacity retention. This could be related to the differences in the degree of ordering in the carbon. While the carbon obtained by the hydrothermal carbonization of glucose may have a significant sp³ component, that obtained after annealing may have a high fraction of the more conductive sp² carbon as reported elsewhere. [Q. Wang,; H. Li,; L. Chen,; X. Huang, Carbon 2001, 39, 2211; X. Sun and Y. Li, Angew. Chem. Int. Ed. 2004, 43, 597]. The highly ordered, conductive sp² carbon in the annealed sample appears to provide improved kinetics during the charge-discharge process.

The present invention provides a LiFePO₄/C nanocomposite obtained by a novel microwave-hydrothermal synthesis approach involving an in situ carbonization exhibits high capacity with excellent cyclability and rate capability in lithium ion cells. The microwave-hydrothermal approach presented is much more rapid (e.g., about 15 minutes) compared to the known methods in the literature (e.g., a few to several hours) to synthesize LiFePO₄, and it has the potential to tune the crystallite size with a high degree of control. The method of the present invention offers a cost effective, energy efficient approach involving inexpensive water as solvent to scale up the production of LiFePO₄/C cathodes for high-power hybrid electric vehicle (HEV) and plug-in hybrid electric vehicle (PHEV) applications as well as other phospho-olivines LiMPO₄ (M=Mn, Fe, Co, and Ni) and their nanocomposites LiMPO₄/C.

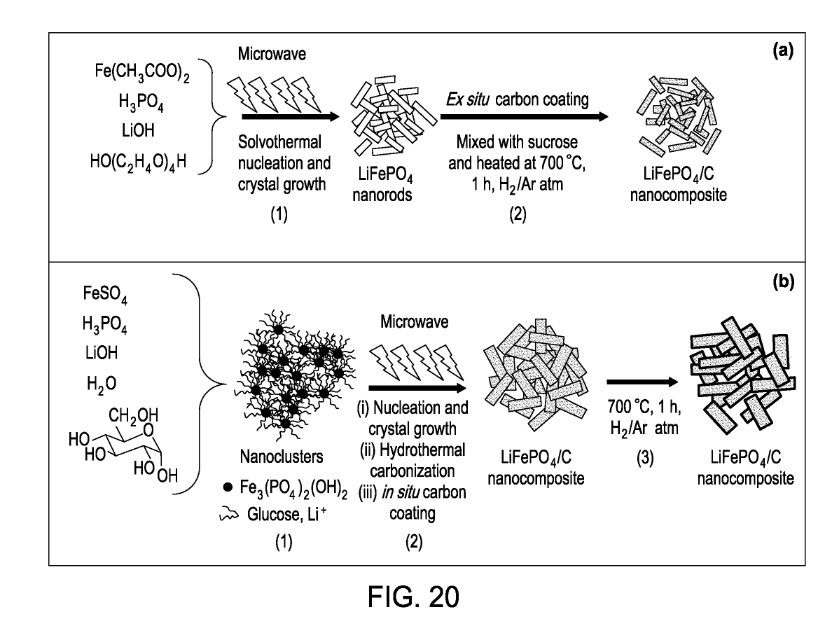

All chemicals were used as received without further purification. De-ionized water and tetraethyleneglycol (TEG) (ACROS-Organics) were used as solvents, respectively, in the microwave-hydrothermal and microwave-solvothermnal synthesis processes illustrated in FIG. 20, employing an Anton Paar, Synthos-3000 microwave synthesis system.

Microwave-solvothermal (MW-ST) synthesis. Lithium hydroxide (Fisher) and iron (II) acetate (GFS-Chemicals) were first dissolved in tetraethyleneglycol (TEG) (ACROS-Organics). H₃PO₄ (85%, Fisher) was then added dropwise to the TEG solution at room temperature to realize a Li:Fe:P molar ratio of 1:1:1 in a quartz vessel. The homogeneous, brown gel reaction mixture was sealed in a closed high-pressure quartz vessel, which was fitted with a pressure and temperature probe housed in a sturdy thermowell and protected from chemical attack. The rotor containing the closed quartz vessels was then placed on a turntable for uniform heating in an Anton Paar microwave synthesis system (Synthos-3000). The desired exposure time and temperature were programmed with the Anton Paar, Synthos-3000 software. The automatic temperature and pressure control system allowed continuous monitoring and control of the internal temperature (±1° C.). The preset profile (desired time, temperature, and pressure) was followed automatically by continuously adjusting the applied power (0-600 W) and pressure (up to 80 bar). The system was operated at a frequency of 2.45 GHz and the temperature was raised to 300° C. and maintained for 5 minutes under the solvothermal condition. The resulting LiFePO₄ nanocrystals were washed repeatedly with acetone until the washings were colorless to ensure the complete removal of TEG and the powder was dried in an air-oven.

Ex situ coating of carbon on LiFePO₄ nanocrystals: the LiFePO₄ nanocrystals obtained by the microwave assisted solvothermal process were mixed with 10 weight % sucrose powder and carbonized in a flowing 2% H₂ and 98% Ar at 700° C. for 1 hour to achieve the carbon coating.

Microwave-hydrothermal (MW-HT) synthesis: A mixed aqueous solution of LiOH (Fisher) and H₃PO₄ (85%, Fisher) was first stirred for few minutes. An aqueous solution of FeSO₄ (Spectrum-Chemicals) was then added to this mixture so that the Li:Fe:P molar ratio was 3:1:1. The reaction solution with a cream colored white precipitate of Fe₃(PO₄)₂ was transferred into a quartz vessel, sealed, and heated at 235° C. for 15 minutes under the microwave-hydrothermal condition. The vessel was then cooled to room temperature and the product was collected, washed with de-ioniozed water and absolute ethanol, and dried in a vacuum oven at 80° C. The sample was subsequently heated in a flowing 2% H₂ and 98% Ar at 700° C. for 1 hour.

An in situ coating of carbon on LiFePO₄ was attempted during the MW-HT process, employing glucose as the carbon source. A mixed aqueous solution of LiOH (Fisher), H₃PO₄ (85%, Fisher), and glucose was first stirred for few minutes. An aqueous solution of FeSO₄ (Spectrum-Chemicals) was then added to this mixture so that the Li:Fe:P molar ratio was 3:1:1 and the LiFePO₄ to carbon ratio in the final product was anticipated to be 95:5 wt. %. The reaction solution with the cream colored white precipitate of Fe₃(PO₄)₂ was then transferred into a quartz vessel, sealed, and heated at 235° C. for 15 minutes under the microwave-hydrothermal condition. A simplified reaction mechanism for carbon coating under the MW-HT condition involves the dehydration of the carbohydrate followed by a polymerization and carbonization of glucose. The vessel was then cooled to room temperature and the black colored product of LiFePO₄/C nanocomposite was collected, washed with de-ionized water and absolute ethanol, and dried in a vacuum oven at 80° C. Further, in order to improve the structural order of the carbon coating, the carbon coated LiFePO₄ powder was subsequently carbonized in 2% H₂ and 98% Ar at 700° C. for 1 hour.

X-ray diffraction (XRD) characterization of the samples was carried out with a Philiphs PW1830 X-ray diffractometer and filtered Cu Kα radiation. Scanning electron microscopy (SEM) and transmission electron microscopy (TEM) characterizations were carried out, respectively, with a JEOL-JSM5610 SEM and a JEOL JEM-2010F equipments. Raman spectroscopic analysis was performed with a Renishaw InVia system utilizing a 514.5 nm incident radiation and a 50× aperture (N.A=0.75), resulting in approximately a 2 μm diameter sampling cross section. Electrochemical performances were evaluated with CR2032 coin cells at 4.3−2.0 V with an Arbin battery cycler. The coin cells were fabricated with the LiFePO₄ or LiFePO₄/C cathode, metallic lithium anode, 1 M LiPF₆ in 1:1 diethyl carbonate/ethylene carbonate electrolyte, and Celgard polypropylene separator. The cathodes were prepared by mixing 75 weight % active materials with 12.5 weight % conductive carbon and 12.5 weight % teflonated acetylene black binder, rolling the mixture into thin sheets, and cutting into circular electrodes of 0.64 cm² area. The electrodes typically had an active material content of about 7 mg, and were dried under vacuum at 80° C. for more than 3 hours before assembling the coin cells in an argon-filled glovebox.

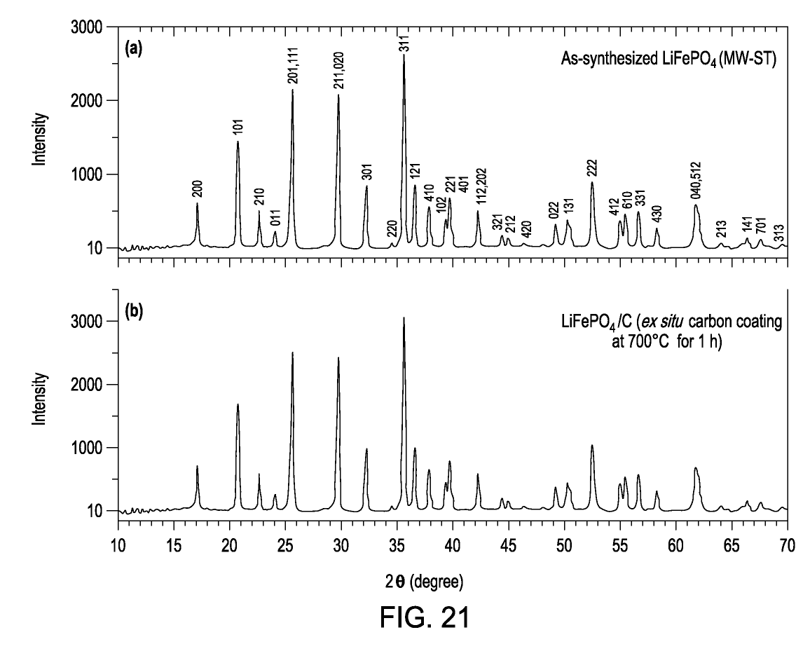

The present invention provides a microwave-hydrothermal and microwave-solvothermnal synthesis processes. FIG. 21A shows the XRD pattern of the as-synthesized LiFePO₄ obtained by the microwave irradiated solvothermal (MW-ST) method using TEG at 300° C. within 5 minutes. FIG. 21B shows the XRD pattern recorded after an ex situ coating at 700° C. with carbon of the LiFePO₄ obtained by the MW-ST method (FIG. 20A). All the reflections in both the samples could be indexed on the basis of an orthorhombic olivine-type LiFePO₄ structure without any detectable impurity phases.

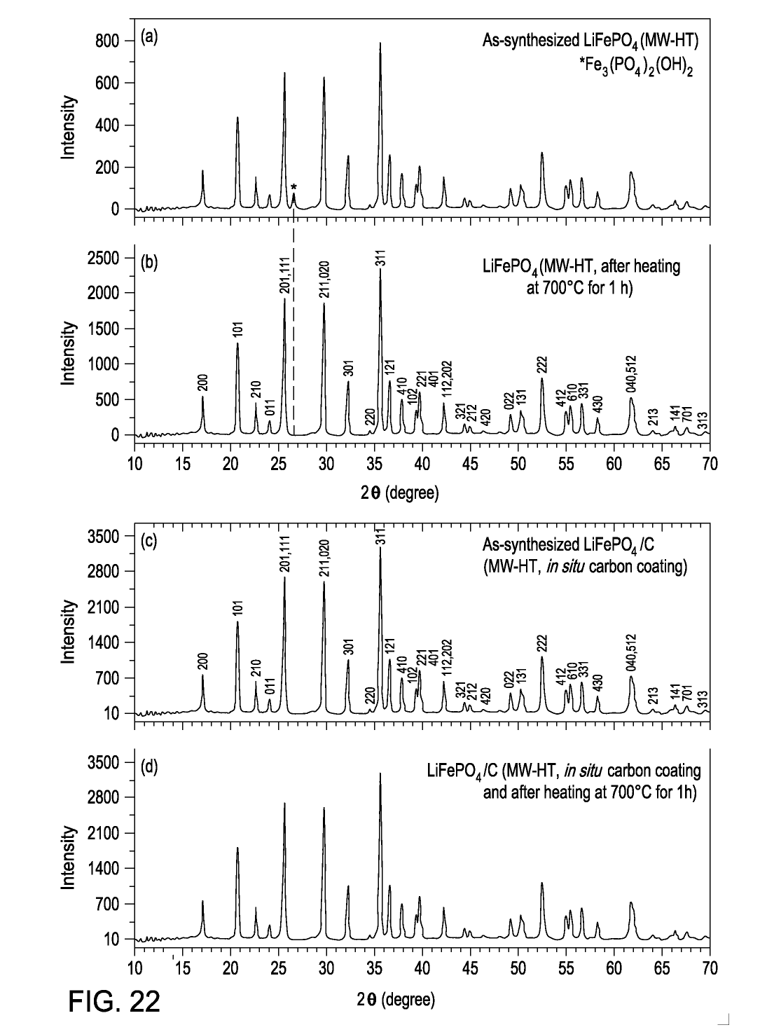

FIGS. 22A-22D show the XRD patterns of the LiFePO₄ and LiFePO₄/C nanocomposite prepared by the MW-HT method (FIG. 20B). Although the as-synthesized sample shows a weak reflection at 2θ=27° corresponding to the impurity phase²⁸ Fe₃(PO₄)₂(OH)₂ in addition to the reflections of LiFePO₄ (FIG. 22A), subsequent annealing at 700° C. in 2% H₂ and 98% Ar for 1 hour offers single phase LiFePO₄ without any impurity phase (FIG. 22B). Interestingly, the as-synthesized LiFePO₄/C nanocomposite prepared at 235° C. for 15 minutes by the one-pot MW-HT process with glucose does not show any impurity phase as seen in FIG. 22C in contrast to the product obtained in FIG. 22A in the absence of glucose. It reveals that hydrothermal carbonization of glucose not only offers the carbon coating but also provides a reducing atmosphere to favor the formation of phase pure LiFePO₄. Subsequent heating of the product at 700° C. for 1 hour in 2% H₂ and 98% Ar maintains the sharp reflections of LiFePO₄ as seen in FIG. 22D while improving the ordered structure of carbon. Nevertheless, no detectable reflections corresponding to carbon could be seen in FIGS. 22C and 22D due to its low content or its amorphous structure. TGA analysis of the product confirmed the carbon content to be 5 weight % in the LiFePO₄/C nanocomposite.

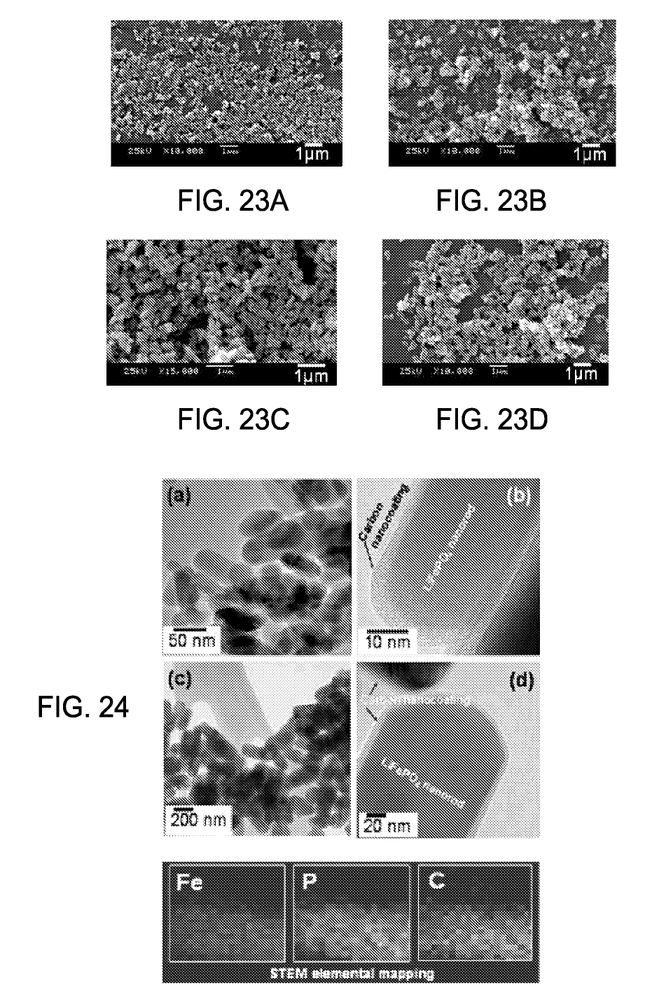

The particle size and shape of the products formed were examined by both SEM and TEM. FIGS. 23A and 23B show the SEM images of the as-synthesized LiFePO₄ obtained by the MW-ST method and the LiFePO₄/C composite obtained by a subsequent ex situ coating of carbon on LiFePO₄ at 700° C. FIGS. 23C and 23D show the SEM images of as-synthesized LiFePO₄/C nanocomposite obtained by the MW-HT method with glucose and the product obtained after subsequent heating at 700° C. All the SEM images reveal a nanorod-like morphology. FIGS. 23B, 23C and 23D also reveal the absence of any bulk deposition or agglomeration of carbon on the surface of LiFePO₄. The images also indicate that no significant change in morphology occurs after heating at 700° C. for 1 hour.

The TEM images in FIG. 24 demonstrate the well-defined crystalline nanorod morphologies with controlled size of the LiFePO₄/C nanocomposites. It is interesting that highly crystalline nanorods are formed in short time of about 5 to 15 minutes under the microwave conditions in contrast to the 5 to 24 hours involved with other conventional methods like the hydrothermal and solvothermal methods. The dimensions of the nanorods depend on the solvents used to prepare LiFePO₄ (e.g. viscosity and boiling point of the solvents), which could help to tune the rate capability and volumetric energy density. For example, while the sample obtained by the MW-ST method with TEG as a solvent shows small nanorods with a width of 25±6 nm and a length of up to 100 nm (FIG. 24A), the sample obtained by the MW-HT method with water as a solvent shows large nanorods with a width of 225±6 nm and a length of up to 300 nm (FIG. 24C). The high resolution TEM images of the LiFePO₄/C nanocomposites in FIGS. 24B and 24D show a uniform carbon nanocoating (amorphous region) on the LiFePO₄ nanorods (crystalline fringe region). The images indicate a “core-shell” structure with a 5 to 12 nm carbon shell on the 25±6 or 225±6 nm LiFePO₄ core. Moreover, the high temperature (700° C.) treatment does not alter the particle size significantly, suggesting that the carbon coating inhibits the crystallite growth normally encountered during high temperature heat treatment. Elemental mapping by scanning TEM (STEM) in FIG. 24 indicates a uniform distribution of Fe, P, and C in the LiFePO₄/C nanocomposite, while energy dispersive spectroscopic analysis of the LiFePO₄ nanocrystals in SEM indicated a Fe:P ratio of 1:1.

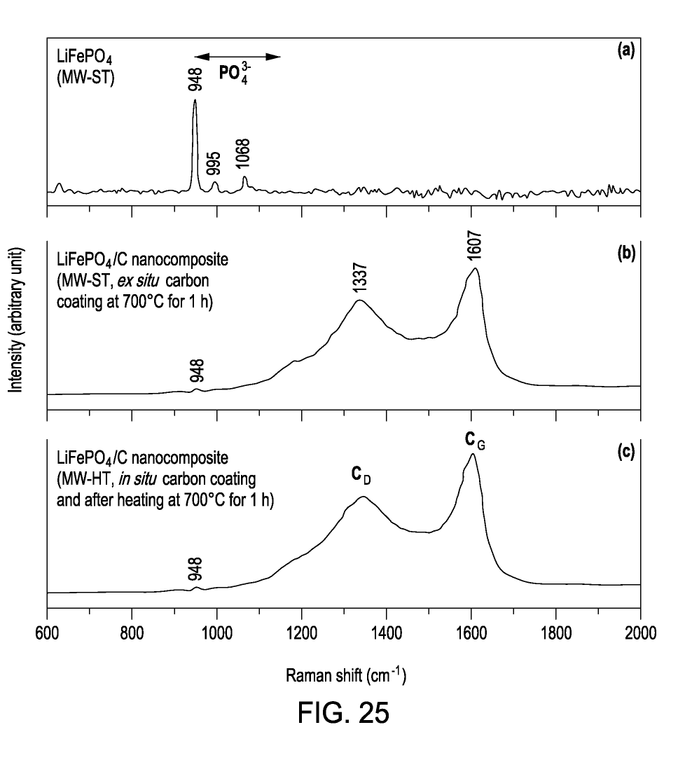

FIGS. 25A-25C are graphs that show the Raman spectra of as-synthesized LiFePO₄. FIG. 25A is a graphs that shows the Raman spectra of as-synthesized LiFePO₄ obtained by the MW-ST method and the LiFePO₄/C nanocomposites obtained by an ex situ coating of carbon at 700° C. on the MW-ST LiFePO₄ and by an in situ coating of carbon on LiFePO₄ by the MW-HT method followed by heating at 700° C. The sharp band at 948 cm⁻¹ along with the bands at 995 and 1068 cm⁻¹ in FIG. 5A can be attributed to the symmetric PO₄³⁻ stretching vibration²⁰ of LiFePO₄. On the other hand, the broad bands in FIGS. 25B and 25C that are characteristic of carbon along with the weak bands of PO₄³⁻ suggest the coating of structurally ordered carbon on LiFePO₄. The strong band at 1607 cm⁻¹ in FIGS. 25B and 25C, which is called the graphite band (G-band), is characteristic of carbon materials with a high degree of ordered structure. This band corresponds to one of the E_{2g} modes arising from the movement in opposite directions of the two neighboring carbon atoms in a graphene sheet. On the other hand, the band observed at 1337 cm⁻¹ in FIGS. 25B and 25C, which is called the disorder-induced phonon mode (D-band), is characteristic of carbon materials with disordered structure.³⁴ The I_{D}/I_{G} value (the peak intensity ratio between the 1337 and 1607 cm⁻¹ peaks) generally provides a useful index for comparing the degree of crystallinity of various carbon materials, i.e., smaller the ratio of I_{D}/I_{G}, higher the degree of ordering in the carbon material. A smaller I_{D}/I_{G} ratio in FIGS. 25B and 25C indicates a high degree of ordering in the carbon coated on LiFePO₄.

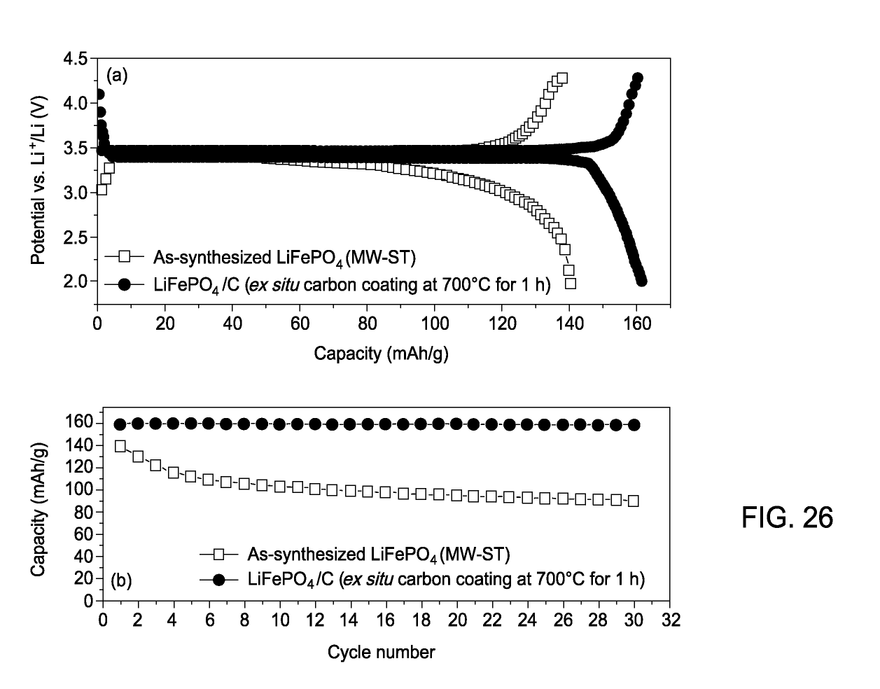

FIGS. 26A and 26B are graphs of the electrochemical properties of the LiFePO₄ and LiFePO₄/C nanocomposite. FIG. 26 compares the first charge-discharge profiles and cyclability of LiFePO₄ and LiFePO₄/C nanocomposite obtained by the MW-ST method. The as-synthesized LiFePO₄ obtained by the MW-ST method exhibits a discharge capacity of 140 mAh/g with a significant voltage difference between the charge and discharge curves as seen in FIG. 26A. It also exhibits a significant capacity fade during the initial cycles as seen in FIG. 26B. Recognizing that the polarization loss could be due to the lack of adequate electronic conductivity, in one embodiment the present invention focuses on an ex situ coating of the LiFePO₄ nanorods with carbon by heating with sucrose at 700° C. for 1 hour the LiFePO₄ obtained by the MW-ST method. The LiFePO₄/C nanocomposite thus obtained exhibits a high discharge capacity of 162 mAh/g, which is close to the theoretical value of 170 mAh/g, with little difference between the charge and discharge curves as seen in FIG. 26A. It also exhibits excellent cyclability with no noticeable fade in 30 cycles as seen in FIG. 26B.

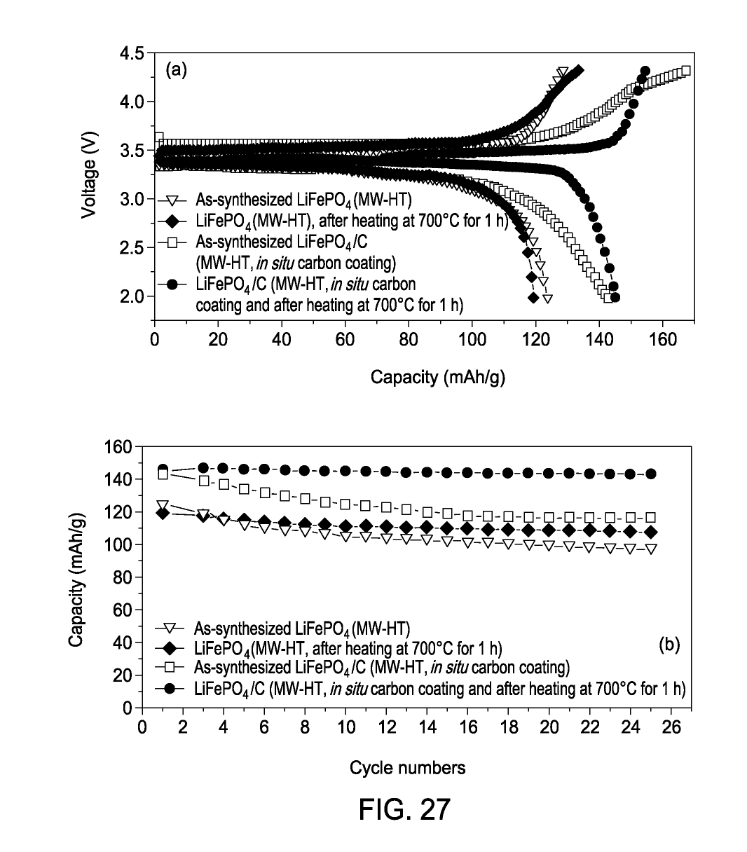

FIGS. 27A and 27B show the first charge-discharge profiles and cyclability of the LiFePO₄ and LiFePO₄/C nanocomposites obtained by the MW-HT method before and after heating at 700° C. FIGS. 27A and 27B show a comparison of the first charge-discharge profiles recorded at C/10 rate between 2.0 and 4.3 V and the cyclability of the as-synthesized LiFePO₄ obtained by the MW-HT method, after heating the MW-HT LiFePO₄ at 700° C. for 1 hour C in a flowing 2% H₂-98% Ar atmosphere, as-synthesized LiFePO₄/C nanocomposite obtained by an in situ carbon coating with glucose during the MW-HT process, and after heating the MW-HT LiFePO₄/C nanocomposite at 700° C. for 1 hour in a flowing 2% H₂ and 98% Ar atmosphere, respectively. The as-synthesized LiFePO₄ obtained by the MW-HT method exhibits a discharge capacity of 123 mAh/g with a significant voltage difference between the charge and discharge curves as seen in FIG. 27A. The lower discharge capacity could be partly due to the presence of the impurity phase Fe₃(PO₄)₂(OH)₂ and larger particle size compared to that obtained by the MW-ST method. It also exhibits capacity fade as seen in FIG. 27B. Although the capacity retention increases slightly on annealing the LiFePO₄ sample obtained by the MW-HT method at 700° C. for 1 hour due to an improvement in crystallinity, the capacity decreases slightly to 120 mAh/g. On the other hand, the as-synthesized LiFePO₄/C nanocomposite obtained by an in situ coating of carbon with glucose during the MW-HT process exhibits a higher discharge capacity of 144 mAh/g (FIG. 27A). Although the capacity increases only slightly to 146 mAh/g on annealing the as-synthesized LiFePO₄/C (MW-HT) nanocmposite at 700° C., the capacity retention improves remarkably as seen in FIG. 27B. The excellent cyclability could be related to a significant improvement in the ordered structure of carbon and the electronic conductivity as has been reported elsewhere.

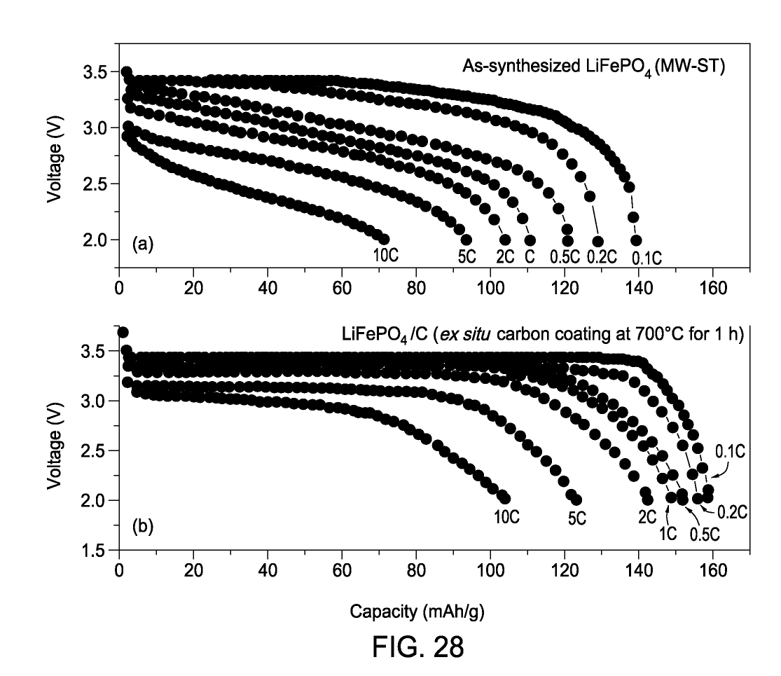

FIGS. 28A and 28B are graphs that compare the rate capabilities (at C/10 to 10C rates) of LiFePO₄ and LiFePO₄/C nanocomposite obtained by the MW-ST method. FIG. 28A is a graph comparing the rate capabilities of the as-synthesized LiFePO₄ nanorods obtained by the MW-ST method and FIG. 28B is a graph comparing the rate capabilities of a LiFePO₄/C nanocomposite obtained by an ex situ carbon coating of the MW-ST LiFePO₄ nanorods by heating with sucrose at 700° C. for 1 hour in a flowing 2% H₂ and 98% Ar atmosphere. The LiFePO₄/C nanocomposite obtained by heating at 700° C. exhibits better rate capability compared to the as-synthesized LiFePO₄.

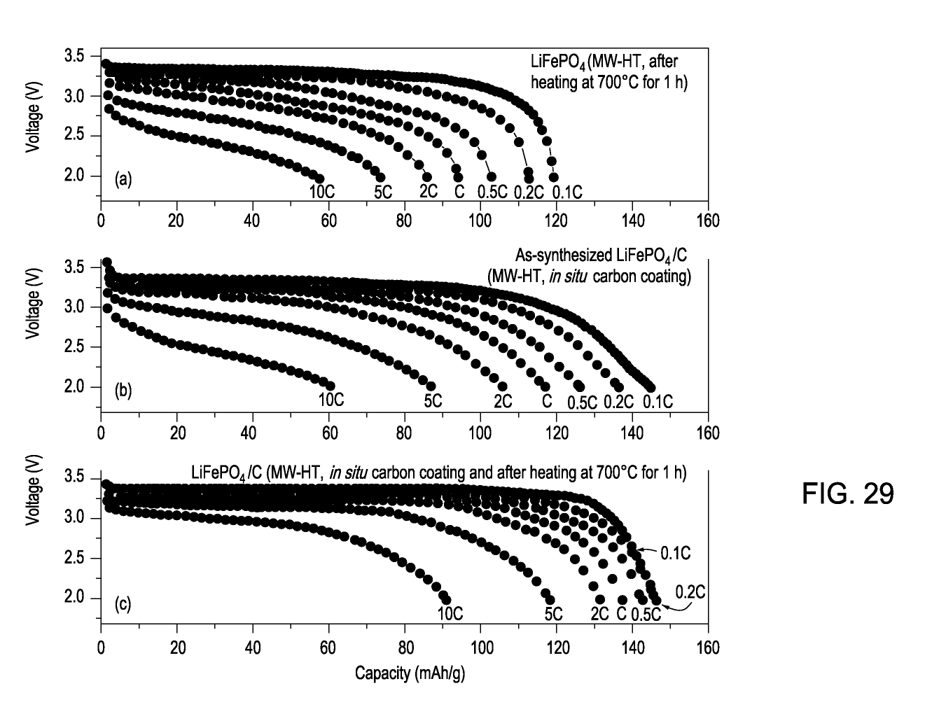

FIGS. 29A, 29B and 29C are graphs that compare the rate capabilities (at C/10 to 10C rates) of LiFePO₄ and LiFePO₄/C nanocomposite obtained by the MW-HT method. FIG. 29A is a graph of the comparison of the rate capabilities of the LiFePO₄ nanorods obtained by the MW-HT method followed by heating at 700° C. for 1 hour in a flowing 2% H₂ and 98% Ar atmosphere, FIG. 29B is a graph comparing the rate capabilities of the as-synthesized LiFePO₄/C nanocomposite obtained by an in situ carbon coating with glucose during the MW-HT process, and FIG. 29C is after heating the LiFePO₄/C nanocomposite in FIG. 29B at 700° C. for 1 hour in a flowing 2% H₂ and 98% Ar atmosphere. The LiFePO₄/C nanocomposite obtained after heating at 700° C. exhibits better rate capability as seen in FIG. 29C than the pristine LiFePO₄ heated at 700° C. (FIG. 29A) and the as-synthesized LiFePO₄/C nanocomposite (FIG. 29B) due to the improved kinetics provided by the structurally ordered, electronically conducting carbon coating on LiFePO₄.

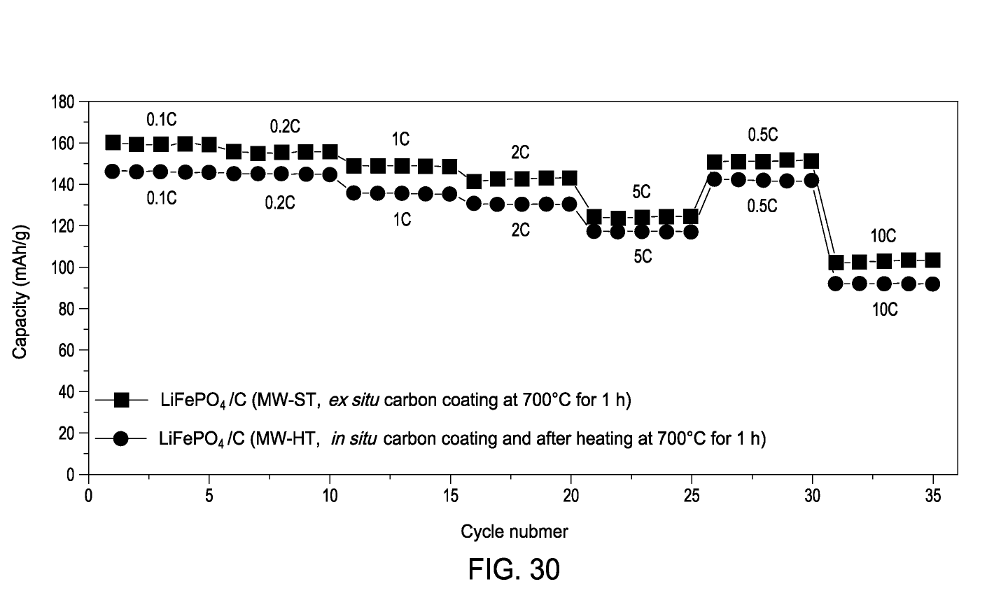

FIG. 30 is a graph that compares the rate capabilities of the LiFePO₄/C nanocomposite obtained by heating the MW-ST LiFePO₄ with sucrose at 700° C. and by heating at 700° C. the LiFePO₄/C nanocomposite obtained by the MW-HT method. FIG. 30A is a graph that compares the rate capabilities of LiFePO₄/C nanocomposite obtained by an ex situ carbon coating of the MW-ST LiFePO₄ nanorods by heating with sucrose at 700° C. for 1 hour in a flowing 2% H₂ and 98% Ar atmosphere and LiFePO₄/C nanocomposite obtained by an in situ carbon coating with glucose during the MW-HT process, followed by heating at 700° C. for 1 hour in a flowing 2% H₂ and 98% Ar atmosphere. Although both samples were subjected to a constant annealing of 1 hour at 700° C., the former exhibits higher initial discharge capacity due to a smaller particle size (25±6 nm and a length of up to 100 nm) compared to the latter (width of 150±6 nm and a length of up to 225 nm). The observation demonstrates that both the lithium ion conduction and electronic conduction play a critical role in controlling the electrochemical properties of LiFePO₄. A smaller lithium diffusion length in the MW-ST sample leads to better electrochemical properties.

The present invention provides a rapid synthesis process taking advantage of microwave irradiation and solvothermal or hydrothermal effect to obtain highly crystalline LiFePO₄ nanorods within a short reaction time (e.g., 5 to 15 minutes) at <300° C. However the skilled artisan will recognize this process may be extended to shorter or longer periods of time in some embodiments, e.g., 0.1-5 minutes, 15-30 minutes, 30-60 minutes, 1-2 hours, 2-6 hours, 6-12 hours or longer than 12 hours, including incremental variations thereof. In addition, the temperature may be varied in some embodiments from 200-225, 225-250, 250-275, 275-300, 300-325, and 325-350° C. The microwave-solvothermal process employing a polyol (TEG) as a sovent offers much smaller particle size than the microwave-hydrothermal process employing water as a solvent, resulting in a higher initial discharge capacity for the former. The LiFePO₄/C nanocomposites annealed at 700° C. for a short time exhibit better cyclability and higher rate capability compared to the as-prepared LiFePO₄ or LiFePO₄/C nanocomposites due to a high degree of ordering in the carbon and enhanced electrical conductivity. Both a short lithium diffusion length and a high electronic conductivity are critical to achieve high performance LiFePO₄ cathodes. The short reaction time involved with these microwave assisted solvothermal and hydrothermal processes has the potential to lower the manufacturing cost with significant energy savings to obtain various phospho-olivines LiMPO₄ (M=Mn, Fe, Co, and Ni) with different nanomorphologies.

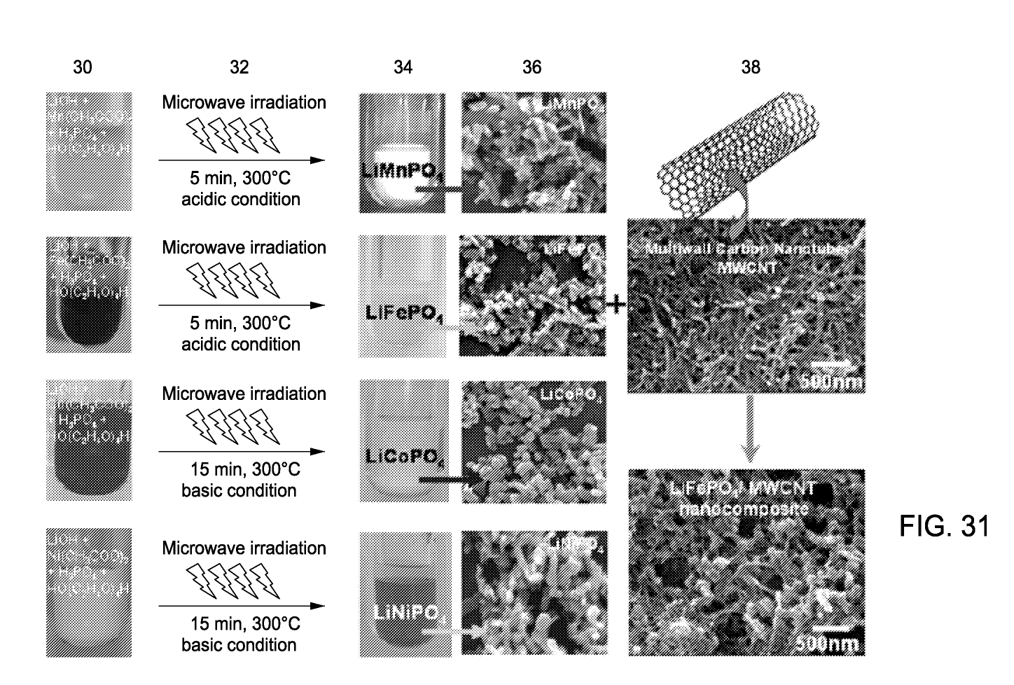

The present invention provides the direct synthesis of LiMPO₄ (M=Mn, Fe, Co, Ni) nanosheets within a short reaction time (e.g., 5 to 15 minutes) using the highly viscous, high boiling tetraethyleneglycol (TEG) solvent via the MW-ST method disclosed herein. In one embodiment a non-aqueous solvent not only provides a reducing environment to prevent the oxidation of M²⁺ to M³⁺, but also helps to prohibit the growth and agglomeration of the nanoparticles formed. The MW-ST method takes advantage of both the microwave irradiation and the solvothermal effect to produce nanocrystalline LiMPO₄. The present invention provides a nano-networking of the LiFePO₄, LiMnPO₄, and LiCoPO₄ formed with MWCNT at ambient temperatures to enhance the mobility of electrons during the lithiation/delithiation process. A schematic representation of the MW-ST process employed and the subsequent networking with MWCNT to obtain the LiMPO₄-MWCNT nanocomposite are shown in FIG. 31.

FIG. 31 is a schematic representation of the MW-ST process to produce nano LiMPO₄ (M=Mn, Fe, Co, Ni) and subsequent nanocomposite formation with MWCNT at ambient temperatures. Column 30 is an image of each sample before treatment under reaction conditions seen in column 32 to form the corresponding products shown in the image shown in column 34. A corresponding SEM image is taken of the products and displayed in column 36. TEM images of the treatment of the product with MWCNT are shown in column 38.

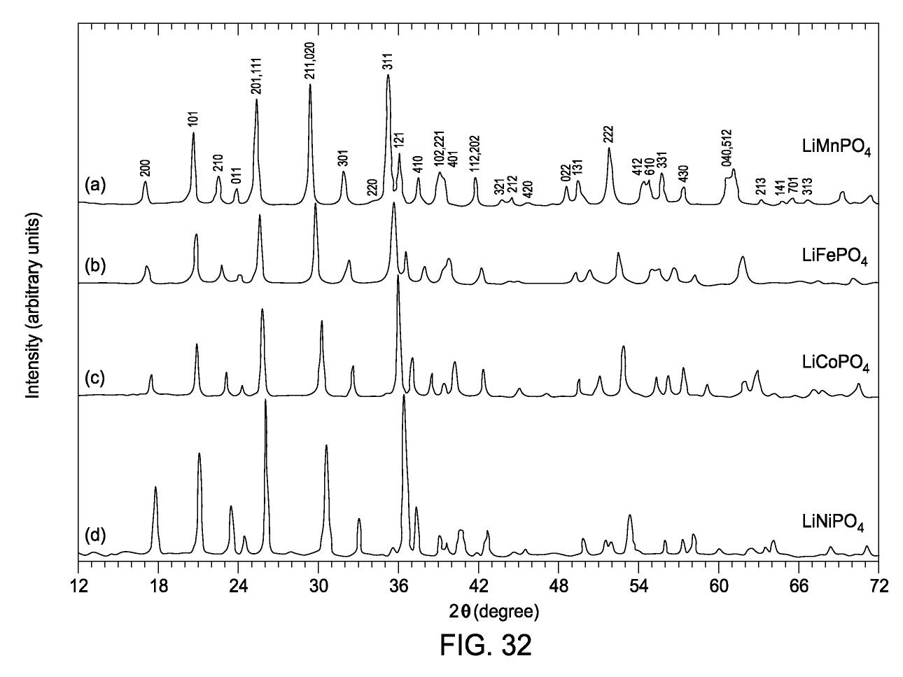

FIG. 32 is an image of the XRD patterns of the nano LiMPO₄ (M=Mn, Fe, Co, Ni) prepared by the MW-ST method within 5 to 15 minutes at 300° C. FIG. 32 shows the XRD patterns of the pristine LiMnPO₄, LiFePO₄, LiCoPO₄, and LiNiPO₄. All the reflections could be indexed on the basis of the orthorhombic olivine structure (space group: Pnma), indicating the formation of phase pure samples without any impurity phases. [Padhi, A. K.; Nanjundasawamy, K. S.; Goodenough, J. B. J. Electrochem. Soc. 1997, 144, 1188; Kim, D.-H.; Kim, J. Electrochem. Solid State Lett. 2006, 9, A439]. The sharp diffraction peaks illustrate the highly crystalline nature of LiMPO₄ achievable by the MW-ST process within a short time without post annealing at elevated temperatures. The reflections in FIG. 32 shift gradually to higher angles on going from M=Mn to Fe to Co to Ni due to the decrease in the ionic radii values. Energy dispersive spectroscopic (EDS) analysis in SEM and atomic absorption spectroscopic analysis of the as-synthesized LiMPO₄ confirmed a Li:M:P ratio of 1:1:1.

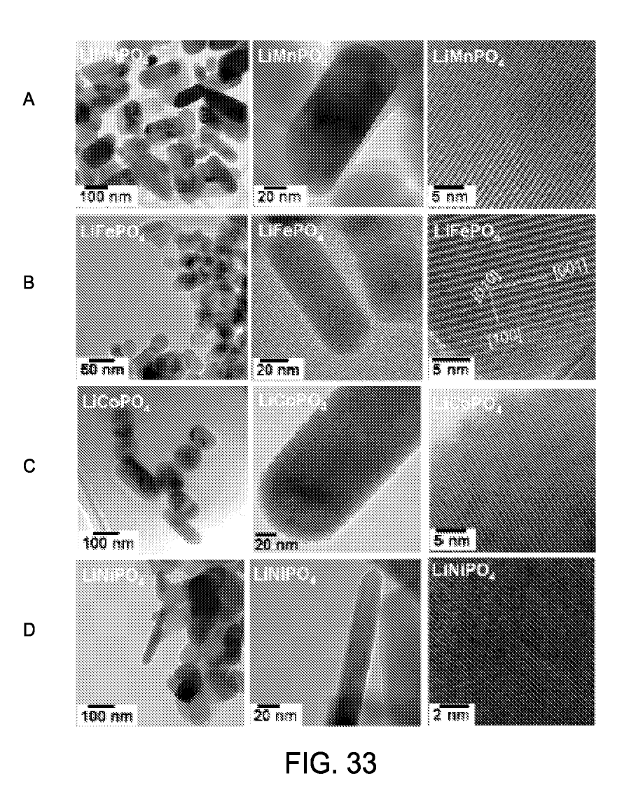

FIGS. 33A, 33B, 33C and 33D are TEM images of LiMPO₄ (M=Mn, Fe, Co, Ni) nanosheets prepared by the MW-ST method within 5 to 15 minutes at 300° C. at increasing magnification. The TEM images shown in FIGS. 33A, 33B, 33C and 33D illustrate the highly crystalline nature of the LiMPO₄ samples with a nanosheet morphology. The high resolution TEM image reveals that the nanosheets grow along the direction with the lithium diffusion direction (the b axis) perpendicular to the nanosheets, which is particularly attractive to achieve fast lithium diffusion and high rate capability. Thus the MW-ST approach presented here offers a unique nanostructure, facilitating fast lithium ion diffusion.

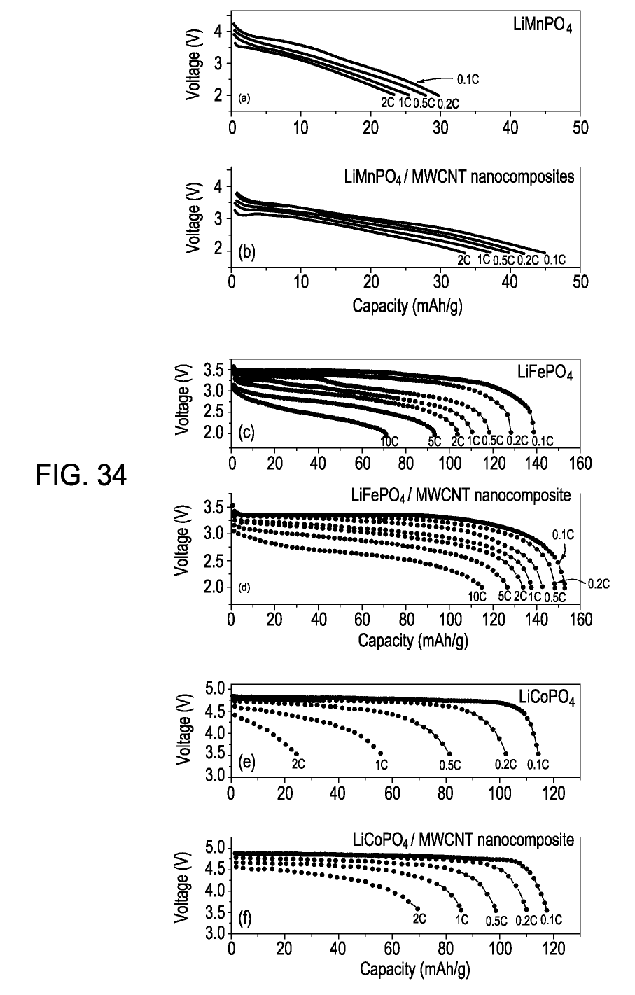

FIGS. 34A, 34B, 34C, 34D, 34E and 34F are graphs that compares the discharge capacity at various C-rates of the LiMPO₄ (M=Mn, Co, Ni) nanosheets before and after networking with MWCNT. Although LiMPO₄ nanosheets have low electronic conductivity, the networking with MWCNT leads to a significant improvement in electronic conductivity and rate capability. Moreover, the lithium diffusion direction (b axis) perpendicular to the nanosheets particularly shortens the diffusion length and enhances the rate capability of the LMPO₄ nanosheets. The superior rate performance of the LiMPO₄-MWCNT nanocomposite is due to the combined effect of the small lithium diffusion path length in the short nanosheets and the electronically conductive matrix provided by the carbon nanotubes. With a theoretical voltage of 5.1 V vs Li/Li⁺, LiNiPO₄ poses an even tougher challenge on the electrolyte issue, and we were not able to carry out the electrochemical tests of the synthesized LiNiPO₄ with the available conventional electrolytes (1 M LiPF₆ in 1:1 diethyl carbonate/ethylene carbonate).

The present invention provides compositions and methods for the synthesis of LiMPO₄ (M=Mn, Fe, Co, Ni) nanosheets within a short reaction time (e.g., 5 to 15 min) by a novel, low cost microwave-solvothermal approach without requiring any elevated temperature post processing in reducing gas atmospheres. Subsequent networking of the LiMPO₄ nanosheets with multi-walled carbon nanotubes at ambient temperatures to obtain LiMPO₄-MWCNT nanocomposite offers high capacity with excellent rate capability. Furthermore, the lithium diffusion direction (b axis) perpendicular to the nanosheets offers particular advantage to achieve fast lithium diffusion and high power capability necessary for automotive applications.

The present invention also includes a method of making a nanostructured phospho-olivine hybrid composition by dissolving lithium hydroxide and one or more metal salts in an aqueous solvent, adding one or more monosaccharides to the solvent, adding H₃PO₄ to the aqueous solvent to form a precursor solution with a 1:1:1 molar ratio of Li:M:P, heating solvothermally the precursor solution with a microwave device, separating the LiMPO₄ nanostructured phospho-olivine material from the precursor solution and encapsulating the LiMPO₄ nanostructured phospho-olivine material with one or more polymers selected from an electronically conductive polymer, a doped polymer, an electronically and ionically conductive polymer, or a combination thereof, wherein the polymer varies from 0.1 weight % to 50 weight %.

The present invention may include the addition of one or more monosaccharides, e.g., Trioses (e.g., Ketotriose (Dihydroxyacetone), Aldotriose (Glyceraldehyde)), Tetroses (e.g., Erythrulose, Erythrose, Threose) Pentoses (e.g., Arabinose, Deoxyribose, Lyxose, Ribose, Ribulose, Xylose, Xylulose), Hexoses (e.g., Glucose, Galactose, Mannose, Gulose, Idose, Talose, Allose, Altrose, Fructose, Sorbose, Tagatose, Psicose, Fucose, Fuculose, Rhamnose), Heptose, Octose, Nonose, Decose, in addition to modifications thereof In addition, the monosaccharides may include one or more modifications to the ring. Furthermore, some embodiments can use disaccharides such as sucrose, lactose, trehalose or maltose. In addition to monosaccharides the present invention may also include disaccharides, polysaccharides, surfactants, biosurfactants, organic acids, polyalcohols or combinations thereof

The microwave irradiated synthesis system operates at a frequency of about 2.0 to 3.0 GHz and a power of 1 to 2,000 W. The skilled artisan will recognize that the operating frequency may be less than 2.0 and greater than 3.0, e.g., 0.1, 0.2, 0.3, 0.4, 0.5, 0.6, 0.7, 0.8, 0.9, 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4.0 and greater. Similarly, the power may be from 1 to 2,000 W, in some instances the power may be less than 1 and greater than 2,000 W. It is also equally understood that the power may be incremental variations thereof.

Generally, the heating raises the temperature from about 100 to about 400° C. for between about 1 minute to about 24 hours. The skilled artisan will recognize that different embodiments of the present invention may be heated at any temperature within that range and includes all incremental variations between those ranges. Similarly, the time can be any time within that range and includes all incremental variations between those ranges. The skilled artisan will readily recognize that this applies to all ranges and temperatures disclosed herein.

The conductive polymers of the present invention include, without limitation, polyanilines (e.g., poly(2-methoxyaniline)), polythiophenes (e.g., poly(3-octylthiophene), and poly(3,4-ethylene dioxythiophene)), and polypyrroles, and their derivatives.

The present invention may also include layers and/or blends of polymers, copolymers and/or conductive polymers, e.g., a polymer blend is poly(3-hexylthiophene) (P3HT), poly(2-methoxyaniline) (“POMA”) or poly(3-octylthiophene) (“POTh”) with PVDF or PEO.

In addition, the electrically conductive material can also be pure elements, metal oxides, metal sulfides, carbon, and conductive polymers, e.g., conducting elements include, carbon black, silver, copper, lithium, nickel, and zinc; conductive polymers include polythiophenes, polyanilines, polypyrroles, poly(alkyl and alkoxythiophenes), and polyetheylenes and their derivatives. Nonlimiting examples of such conducting polymers include, without limitation, poly (3-octylthiephene), poly(3-hexylthiophene), poly(3,4-ethylenedioxythiophene). Exemplary conductive oxides include, without limitation, vanadium oxide, indium tin oxide, titanium oxide, manganese oxide, nickel oxide, ruthenium oxide, molybdenum oxide, tungsten oxide, or their alloys.

In addition, the present invention includes coating materials that may be a conducting polymer, such as a single polymer, or a polymer blend that includes a conductive polymer and a secondary material (e.g., a fluorinated polymer, blends include poly(3,4-ethylene dioxythiophene) (“PEDOT”) or poly(3,4 ethylene dioxythiophene)-polystyrene sulfonate (“PEDT-PSS”), poly(3,4-ethylenedioxypyrrole) (“PEDOP”), poly(3-hexylthiophene) (“P3HT”), where the secondary material includes polytetrafluoroethylene (“PTFE”) or derivatives thereof or poly(vinylidene fluoride)(“PVDF”). In other embodiments, the coating layer includes at least one polytetrafluoroethylene, poly(vinylidene fluoride) and poly(ethylene oxide).

The coating material can include a dopant that improves the conductivity of the conducting material. The dopant can be, but is not limited to, a counter-ion source including, without limitation, polystyrene sulfonate, hydrochloric acid, tosylate ion, camphorsulfonic acid, dodecylbenzene sulfonic acid, perfluorodecane sulfonic acid, trifluoroacetic acid, or perchloric acid.

The phospho-olivine structures of the present invention may have a particle size that ranges from 1 to 1000 nm, e.g., the particles may be 1, 2 , 3, 4, 5, 6, 7, 8, 9, 10, 20 , 30, 40, 50, 60, 70, 80, 90, 100, 200 , 300, 400, 500, 600, 700, 800, 900, 1000 nm and incremental variations of the sizes listed herein, e.g., 101, 7.5, 604.7 and so forth.

As used herein the term “solvothermally” may be used in its broadest sense to denote heating of a solvent where the solvent is an aqueous solvent or a non-aqueous solvent or a mixture thereof. More specifically, the term may be used to specify heating of a non-aqueous solvent or a solvent that is predominantly a non-aqueous solvent. As used herein the term “hydrothermally” is used to refer to the heating of an aqueous solvent or a solvent that is predominantly an aqueous solvent.

It is contemplated that any embodiment discussed in this specification can be implemented with respect to any method, kit, reagent, or composition of the invention, and vice versa. Furthermore, compositions of the invention can be used to achieve methods of the invention.

It will be understood that particular embodiments described herein are shown by way of illustration and not as limitations of the invention. The principal features of this invention can be employed in various embodiments without departing from the scope of the invention. Those skilled in the art will recognize, or be able to ascertain using no more than routine experimentation, numerous equivalents to the specific procedures described herein. Such equivalents are considered to be within the scope of this invention and are covered by the claims.

All publications and patent applications mentioned in the specification are indicative of the level of skill of those skilled in the art to which this invention pertains. All publications and patent applications are herein incorporated by reference to the same extent as if each individual publication or patent application was specifically and individually indicated to be incorporated by reference.

The use of the word “a” or “an” when used in conjunction with the term “comprising” in the claims and/or the specification may mean “one,” but it is also consistent with the meaning of “one or more,” “at least one,” and “one or more than one.” The use of the term “or” in the claims is used to mean “and/or” unless explicitly indicated to refer to alternatives only or the alternatives are mutually exclusive, although the disclosure supports a definition that refers to only alternatives and “and/or.” Throughout this application, the term “about” is used to indicate that a value includes the inherent variation of error for the device, the method being employed to determine the value, or the variation that exists among the study subjects.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, MB, BBC, AAABCCCC, CBBAAA, CABABB, and so forth. The skilled artisan will understand that typically there is no limit on the number of items or terms in any combination, unless otherwise apparent from the context.

All of the compositions and/or methods disclosed and claimed herein can be made and executed without undue experimentation in light of the present disclosure. While the compositions and methods of this invention have been described in terms of preferred embodiments, it will be apparent to those of skill in the art that variations may be applied to the compositions and/or methods and in the steps or in the sequence of steps of the method described herein without departing from the concept, spirit and scope of the invention. All such similar substitutes and modifications apparent to those skilled in the art are deemed to be within the spirit, scope and concept of the invention as defined by the appended claims.

What is claimed is:

1 A nanostructured phospho-olivine composition comprising:
LiₓM_{y}PO₄, wherein x is between 0 and 1.2 and y is between 0.8 and 1.2 and M is one or more elements selected from the group consisting of Fe, Mn, Co, Ti, Ni, Cu, V, Mo, Zn, Mg, Cr, Al, Ga, B, Nb, Zr or combinations thereof.

2. The composition of claim 1, wherein the nanostructured phospho-olivine composition comprises LiMnPO₄, LiFePO₄, LiCoPO₄, LiNiPO₄, LiCuPO₄, or combinations thereof.

3. The composition of claim 1, further comprising one or more dopants to form a composition selected from a LiₓFe_{1-y}M_{y}PO₄ composition, a LiₓMn_{1-y}M_{y}PO₄ composition, a LiₓNi_{1-y}M_{y}PO₄ composition, a LiₓCo_{1-y}M_{y}PO₄ composition, and a LiₓCu_{1-y}M_{y}PO₄ composition, wherein x is between 0 and 1, y is between 0 and 1, and M is selected from the group consisting of Mn, Fe, Co, Ti, Ni, Cu, V, Mo, Zn, Mg, Cr, Al, Ga, B, Zr, and Nb.

4. The composition of claim 1, wherein the phospho-olivine comprises a nanomorphology selected from a nanorod nanomorphology, a nanowire nanomorphology, a nanosphere nanomorphology, a nanowhisker nanomorphology, a nanoflower nanomorphology, a nanosheet nanomorphology and combinations thereof wherein the nanomorphology provides fast lithium ion diffusion and facilitates high power capability with an easy lithium diffusion direction (b-axis) perpendicular to the nanomorphology.

5. The composition of claim 1, wherein the phospho-olivine has a particle size of 2 nm to 900 nm.

6. The composition of claim 1, wherein the nanostructured phospho-olivine composition comprises a coating, an electrode or a combination thereof.

7. A method of making a nanostructured phospho-olivine material comprising the steps of:
dissolving a lithium-containing compound such as lithium hydroxide and one or more metal salts in a solvent;
adding H₃PO₄ or a phosphate-containing compound to the solvent to form a precursor solution with a 1:1:1 molar ratio of Li:M:P;
heating solvothermally or hydrothermally the precursor solution with a microwave irradiated synthesis system in the presence or absence of a carbon precursor to form a nanostructured phospho-olivine LiMPO₄ material, wherein the microwave irradiated synthesis system operates at a frequency of between 1.5 and 3.5 GHz and a power of between 1 and 3,000 W; and
separating the nanostructured phospho-olivine LiMPO₄ material from the precursor solution.

8. The method of claim 7, wherein the one or more metal salts comprise Fe, Mn, Co, Ti, Ni, Cu, V, Mo, Zn, Mg, Cr, Al, Ga, B, Zr, Nb or combination thereof and are in the form of metal acetates, metal nitrates, metal chlorides, metal carbonates, metal oxalates, metal sulfates, metal alkoxides or a combination thereof.

9. The method of claim 8, wherein the solvent comprises an aqueous solvent or a nonaqueous solvent, wherein the aqueous solvent comprises water and acidic and basic solutions.

10. The method of claim 7, wherein the solvent comprises high boiling polyol, tetraethyleneglycol, triethyleneglycol, ethyleneglycol, (tri-n-octylphosphine oxide), (tri-n-octylphosphine), (tri-n-butylphosphine), tri-n-octylamine, squalene, octacosane, 1-ethyl-3-methylimidazolium bis(fluorosulfonyl)imide (EMI-FSI), 1-ethyl-3-methylimidazolium bis(trifluoromethanesulfonyl)imide (EMI-TFSI), 1-butyl-2,3-dimethylimidazolium bis(trifluoromethanesulfonyl)imide (BMMI-TFSI), 1-propyl-1-methylpyrrolidinium, bis(fluorosulfonyl)imide (Py13-FSI), 1-butyl-1-methylpiperidinium bis(trifluoromethanesulfonyl)imide (Pp14-TFSI), and N-trimethyl-N-butylammonium bis(trifluoromethanesulfonyl)imide (TMBA-TFSI), or combinations thereof.

11. The method of claim 7, wherein the heating raises the temperature from about 100 to about 400° C. for between about 1 minute to about 24 hours.

12. The method of claim 7, further comprising the step of encapsulating the nanostructured phospho-olivine LiMPO₄ material with a polymer of between 0.1 wt % and 50 wt %, wherein the polymer is selected from an electronically conductive polymer, a doped polymer, an electronically and ionically conductive polymer, or a combination thereof.

13. The method of claim 12, wherein the polymer comprises polypyrrole, polyaniline, polythiophene, poly-p-phenylenevinylene, poly(alkyl and alkoxythiophenes), poly(3,4-ethylenedioxythiophene) (PEDOT), poly(3,4-ethylenedioxypyrrole), (PEDOP), poly(3-hexylthiophene),( P3HT), and their substituted derivatives or doped derivatives.

14. The method of claim 12, further comprising the step of adding one or more dopants to the polymer.

15. The method of claim 14, wherein the one or more dopants comprises polystyrene sulfonate, hydrochloric acid, tosylate ion, camphorsulfonic acid, dodecylbenzene sulfonic acid, perfluorodecane sulfonic acid, trifluoroacetic acid, perchloric acid, or combinations thereof.

16. The method of claim 7, further comprising the step of forming the nanostructured phospho-olivine LiMPO₄ material into an electrode.

17. The method of claim 16, further comprising the step of adding p-toluene sulfonic acid doped poly(3,4-ethylenedioxythiophene) to modify the nanostructured phospho-olivine hybrid composition to improve the electronic and ionic conductivity.

18. The method of claim 12, further comprising the step of modifying the nanostructured phospho-olivine LiMPO₄ material by multi-wall carbon nanotubes (MWCNT), carbon nanofibers, or a combination thereof.

19. The method of claim 7 further comprising the step of modifying the nanostructured phospho-olivine LiMPO₄ material by both ex-situ and in-situ carbon coating, conductive oxide coating, conductive ceramic coating, conductive metal or alloy coating, conductive polymer coating, or combinations thereof.

20. The method of claim 7 wherein the carbon precursors include monosaccharides, disaccharides, polysaccharides, surfactants, biosurfactants, organic acids, polyalcohols or combinations thereof followed by heating at 100-800° C.

21. A method of making a nanostructured phospho-olivine material comprising the steps of:
dissolving a lithium-containing compound such as lithium hydroxide, iron (II) and one or more metal salts in a solvent, wherein the solvent is an aqueous solvent or a non-aqueous solvent;
adding H₃PO₄ or a phosphate-containing compound to the solvent to form a precursor solution with a 1:1:1 molar ratio of Li:Fe(M):P;
heating solvothermally or hydrothermally the precursor solution with a microwave device in the presence or absence of a carbon precursor; and
separating a nanostructured LiₓFe_{1-y}M_{y}PO₄ phospho-olivine material from the precursor solution.

22. The method of claim 21, further comprising the step of adding one or more monosaccharides to the solvent.

23. The method of claim 21, further comprising the step of encapsulating the nanostructured LiₓFe_{1-y}M_{y}PO₄ phospho-olivine material with a polymer, wherein the polymer varies from 0.1 wt % to 50 wt % and the polymer is selected from an electronically conductive polymer, a doped polymer, an electronically and ionically conductive polymer, or a combination thereof.

24. The method of claim 21, wherein the polymer comprises polypyrrole, polyaniline, polythiophene, poly-p-phenylene vinylene, poly(alkyl and alkoxythiophenes), poly(3,4-ethylenedioxythiophene) (PEDOT) and their substituted derivatives or doped derivatives.

25. The method of claim 21, further comprising the step of adding one or more dopants to the polymer, wherein the one or more dopants are selected from polystyrene sulfonate, hydrochloric acid, tosylate ion, camphorsulfonic acid, dodecylbenzene sulfonic acid, perfluorodecane sulfonic acid, trifluoroacetic acid, perchloric acid, or combinations thereof.

26. A method of making a nanostructured phospho-olivine hybrid composition comprising the steps of:
dissolving a lithium-containing compound such as lithium hydroxide and one or more metal salts in an aqueous solvent;
adding one or more monosaccharides to the solvent;
adding H₃PO₄ or a phosphate-containing compound to the aqueous solvent to form a precursor solution with a 1:1:1 molar ratio of Li:M:P;
heating hydrothermally the precursor solution with a microwave device that operates at a frequency of between 1.5 and 3.5 GHz and a power of between 1 and 3,000 W;
separating the LiMPO₄ nanostructured phospho-olivine material from the precursor solution; and
encapsulating the LiMPO₄ nanostructured phospho-olivine material with one or more polymers selected from an electronically conductive polymer, a doped polymer, an electronically and ionically conductive polymer, or a combination thereof, wherein the polymer varies from 0.1 wt % to 50 wt %.

27. The method of claim 26, further comprising the step of adding an iron (II) composition to the aqueous solvent to form a nanostructured phospho-olivine material having the formula LiₓFe_{1-y}M_{y}PO₄.

28. The method of claim 26, wherein the polymer comprises polypyrrole, polyaniline, polythiophene, poly-p-phenylene vinylene, poly(alkyl and alkoxythiophenes), poly(3,4-ethylenedioxythiophene) (PEDOT and their substituted derivatives or doped derivatives.

29. The method of claim 26, further comprising the step of adding one or more dopants to the one or more polymers, wherein the one or more dopants comprises polystyrene sulfonate, hydrochloric acid, tosylate ion, camphorsulfonic acid, dodecylbenzene sulfonic acid, perfluorodecane sulfonic acid, trifluoroacetic acid, perchloric acid, or combinations thereof.

30. The method of claim 26, further comprising the step of adding p-toluene sulfonic acid doped poly(3,4-ethylenedioxythiophene) to modify the nanostructured phospho-olivine hybrid composition to improve the electronic and ionic conductivity.

31. A method of making a nanostructured phospho-olivine hybrid composition comprising the steps of:
dissolving a lithium-containing compound such as lithium hydroxide and one or more metal salts in a non-aqueous solvent;
adding H₃PO₄ or a phosphate-containing compound to the non-aqueous solvent to form a precursor solution with a 1:1:1 molar ratio of Li:M:P;
heating solvothermally the precursor solution with a microwave device that operates at a frequency of between 1.5 and 3.5 GHz and a power of between 1 and 3,000 W;
separating the LiMPO₄ nanostructured phospho-olivine material from the precursor solution; and
encapsulating the LiMPO₄ nanostructured phospho-olivine material with one or more polymers selected from an electronically conductive polymer, a doped polymer, an electronically and ionically conductive polymer, or a combination thereof, wherein the polymer varies from 0.1 wt % to 50 wt %.

32. The method of claim 31, further comprising the step of adding a iron (II) composition to the non-aqueous solvent to form a nanostructured phospho-olivine material having the formula LiₓFe_{1-y}M_{y}PO₄.

33. The method of claim 31, wherein the polymer comprises polypyrrole, polyaniline, polythiophene, poly-p-phenylene vinylene, poly(alkyl and alkoxythiophenes), poly(3,4-ethylenedioxythiophene) (PEDOT and their substituted derivatives or doped derivatives.

34. The method of claim 31, further comprising the step of adding one or more dopants to the one or more polymers, wherein the one or more dopants comprises polystyrene sulfonate, hydrochloric acid, tosylate ion, camphorsulfonic acid, dodecylbenzene sulfonic acid, perfluorodecane sulfonic acid, trifluoroacetic acid, perchloric acid, or combinations thereof.

35. The method of claim 31, further comprising the step of adding p-toluene sulfonic acid doped poly(3,4-ethylenedioxythiophene) to modify the nanostructured phospho-olivine hybrid composition to improve the electronic and ionic conductivity.
